(19) United States
(12) Patent Application Publication
(10) Pub. No.: US 2014/0145991 A1
(43) Pub. Date: May 29, 2014

(54) INFORMATION PROCESSING APPARATUS INSTALLED WITH TOUCH PANEL AS USER INTERFACE

(71) Applicant: Konica Minolta, Inc., Chiyoda-ku (JP)

(72) Inventors: Yoshiyuki TAMAI, Toyohashi-shi (JP); Yoichi Kurumasa, Toyokawa-shi (JP); Takayuki Nabeshima, Toyokawa-shi (JP); Koichi Nagata, Toyohashi-shi (JP); Jun Yokobori, Sagamihara-shi (JP)

(73) Assignee: Konica Minolta, Inc., Chiyoda-ku (JP)

(21) Appl. No.: 14/091,850

(22) Filed: Nov. 27, 2013

(30) Foreign Application Priority Data
Nov. 29, 2012 (JP) 2012-260875

(51) Int. Cl. G06F 3/041

(52) U.S. Cl. CPC G06F 3/0416
USPC 345/173

(57) ABSTRACT

An information processing apparatus includes a detection unit capable of detecting first and second touch positions on a touch panel touched by first and second objects, respectively, a storage unit that stores the first and second touch positions and holds a final touch position as the touch position after each touch is released, a calculation unit that calculates a position obtained by a predetermined rule from the first and second touch positions stored by the storage unit, and a determination unit that determines whether an operation performed on the touch panel is an operation of moving a display content displayed on the touch panel, or an operation of rotating or changing a size of a display content displayed on the touch panel, based on whether the position calculated by the calculation unit is moved, a speed of movement, or an amount of movement.

This application is based on Japanese Patent Application No. 2012-260875 filed with the Japan Patent Office on Nov. 29, 2012, the entire content of which is hereby incorporated by reference.

### BACKGROUND OF THE INVENTION

1. Field of the Invention

The present invention relates to an information processing apparatus, and more particularly to an information processing apparatus installed with a touch panel as a user interface.

2. Description of the Background Art

Image forming apparatuses (for example, MFPs (Multi-Function Peripherals) having scanner, facsimile, copy, printer, data communication, and server functions, facsimile machines, copiers, and printers), which process image data, are also called image processing apparatuses and installed with an information processing apparatus that processes information of operations on the apparatus by users and information to be displayed to users.

An information processing apparatus is installed as a user interface not only in image forming apparatuses but also in smart phones, tablet terminals, PCs (Personal Computers), home appliances, office appliances, and controllers. An information processing apparatus is generally known in which a transparent touch panel is overlaid on a display device such as a liquid crystal display, and a display content on the display device is changed in synchronization with an operation on the touch panel.

For example, a display device of a smart phone, a tablet terminal, and the like can detect a complicated gesture operation performed by a user, such as a single touch operation and a multi-touch operation (see Documents 1 and 2 below).

Document 1 below discloses a device in which a gesture set is defined for a multi-touch detection area of a display device, and when an operation is detected in the multi-touch detection area, one or more gesture events included in the gesture set are specified.

Document 2 below discloses a technique that allows a user to perform a multi-touch operation on a region of a display device in which a multi-touch flag is set.

Document 3 below discloses a method of determining a scroll input if a user's input to a touch panel is a touch at one point, and determining a gesture input if a user's input is a touch at two or more points.

In recent years, image forming apparatuses such as network printers and MFPs that detect complicated gesture operations by users to enable job setting operations become popular. Users can efficiently perform operations of setting jobs and confirming image data by performing a variety of gesture operations on the operation panels of those image forming apparatuses. Examples of the gesture operations include single-tap, double-tap, long-tap, scroll (flick), drag, pinch-in, pinch-out, and rotate.

Here, “single-tap” refers to an operation of touching one point on the screen (touch panel included in the operation panel) with a fingertip and then immediately releasing the fingertip from the screen.

“Double-tap” refers to an operation of performing the same operation as the single-tap operation twice within a predetermined time.

“Long-tap” refers to an operation of keeping touching one point on the screen for a certain time or longer without moving the touch position.

“Scroll” refers to an operation of touching one point on the screen with a fingertip, quickly moving the touch position in the scroll moving direction with the fingertip on the screen, and releasing the fingertip from the screen. The scroll is also called “flick”.

“Drag” refers to an operation of touching one point of the screen with a fingertip, moving the touch position with the fingertip on the screen, and releasing the fingertip at a different point. The direction in which the touch position is moved may not be a straight direction, and the moving speed may be relatively low. The drag operation can be performed on an icon image to move the display position of the icon image to a desired position.

“Pinch-in” refers to an operation of reducing the distance between two points on the screen with two fingertips touching the two points. This pinch-in operation allows a display image to be displayed in a reduced size.

“Pinch-out” refers to an operation of increasing the distance between two points on the screen with two fingertips touching the two points. This pinch-out operation allows a display image to be displayed in an enlarged size. “Pinch-in” and “pinch-out” are collectively called “pinch operation”.

“Rotate” refers to an operation of moving two points on the screen so as to rotate the position of the two points with two fingertips touching the two points. This rotation operation allows a display image to be displayed in a rotated state.

“Touch” refers to a state in which a fingertip is in contact with the screen. “Touch-release” refers to that a fingertip is lifted from the screen after a touch. Touch may be performed with a finger or with a pen or the like.

The information processing apparatus as described above is preliminarily installed with a plurality of operation event determination routines for operation events to be detected, in order to accurately detect gesture operations performed by users. Examples of the operation events to be detected include single-tap, double-tap, long-tap, scroll (flick), drag, pinch-in, pinch-out, and rotate. When a user's input operation on the operation panel is detected, all the plurality of operation event determination routines are successively activated. The information processing apparatus thus specifies the operation event corresponding to the input operation performed by the user and performs processing corresponding to the specified operation event.
[Document 1] Japanese Translation of PCT Application No. 2009-525538
[Document 2] Japanese Laid-Open Patent Publication No. 2009-211704
[Document 3] U.S. Pat. No. 7,844,915

In conventional equipment, what gesture operation is performed by a user is determined by a plurality of operation event determination routines in the following manner.

For example, single-tap, double-tap, and long-tap are operations of lifting (releasing) a finger from the screen with the touch position kept unchanged after the finger touches the screen. Therefore, those operations can be clearly distinguished from the other operation group including scroll, drag, pinch-in, pinch-out, and rotate. In the case of the operation (tap operation) of lifting a finger from the screen with the touch position kept unchanged after a touch on the screen, which of single-tap, double-tap, and long-tap operations is performed can be determined. This determination can be made by determining the number of times of taps or the time during which the fingertip is in contact with the screen.

Scroll, drag, pinch-in, pinch-out, and rotate are operations of changing the touch position with the screen being touched. Therefore, those operations can be clearly distinguished from the other operation group including single-tap, double-tap, and long-tap.

Scroll and drag are operations of moving a display content on the touch panel. Pinch-in and pinch-out are operations of changing the size of a content displayed on the touch panel. Rotate is an operation of rotating a content displayed on the touch panel. Scroll and drag are performed with one finger. By contrast, pinch-in, pinch-out, and rotate are performed with two fingers.

More specifically, in pinch-in or pinch-out, two points on the screen are touched. Which of pinch-in and pinch-out is performed is determined by whether the distance between the two points is reduced or increased. The midpoint between the touched two points serves as the center of a size change (the center (reference point) of enlargement/reduction of an image).

In rotate, two points on the screen are touched. It is determined that a rotate operation is performed, based on that these two points are rotated in a predetermined direction (clockwise or counterclockwise) about the midpoint of the two points. The midpoint between the touched two points serves as the center of rotation of an image.

As described above, scroll and drag are performed with one finger. Pinch-in, pinch-out, and rotate are performed with two fingers. Therefore, conventionally, gesture operations are detected as follows.

Namely, it is determined whether one point or two points are touched on the screen. If it is determined that one point is touched, and if the touch position is moved, it is determined that a scroll or drag operation is performed.

If it is determined that two points are touched, and if the touch positions are moved, it is determined that a pinch-in, pinch-out, or rotate operation is performed.

FIG. 24 is a flowchart partially showing a gesture determination process according to a conventional technique.

The process in the flowchart in FIG. 24 is repeatedly performed at predetermined time intervals (for example, every 20 milliseconds).

Referring to the figure, in step S201, it is determined whether the touch/release state on the screen is changed.

Here, the determination is YES when

(A) a state in which no touch is made changes to a state in which one or more points are touched;

(B) a state in which one or more points are touched changes to a state in which no touch is made; or

(C) the number of points of a touch is changed.

If NO in step S201, in step S203, the touch coordinates on the screen (touch position) are detected. If a plurality of points are touched, the coordinates of all of them are detected.

In step S205, it is determined whether the detected touch coordinates are changed from the previous detection. If YES, in step S207, the number of touch points on the screen is detected. In step S209, if the number of touch points is one or less, the touch coordinates are detected in step S211. In step S213, an imaging process in accordance with a scroll or drag operation is performed.

On the other hand, if the number of touch points is two or more in step S209, in step S215, the touch coordinates are detected. In step S217, the coordinates of the midpoint of the touch points are calculated. In step S219, an imaging process in accordance with a pinch operation or a rotate operation is performed with reference to the coordinates of the midpoint.

If YES in step S201, the process proceeds to step S207. If NO in step S205, the process in the flowchart ends.

The conventional method as described above has the following problems.

For example, it is assumed that the user slides a finger on the screen in order to perform scrolling. Here, the number of touch points is acquired at predetermined time intervals (for example, every 20 milliseconds) (step S207 in FIG. 24). In addition, the process of determining the number of touch points (a touch on one point or a touch on two or more points) is performed at predetermined time intervals (for example, every 20 milliseconds) (step S209). The process of specifying the motion of the finger is thereafter performed (steps S211, S213).

When the user performs a pinch operation, the number of touch points is acquired at predetermined time intervals (for example, every 20 milliseconds) (step S207 in FIG. 24). In addition, the process of determining the number of touch points (a touch at one point or a touch at two or more points) is performed at predetermined time intervals (for example, every 20 milliseconds) (step S209). The process of specifying the motion of the finger is thereafter performed (steps S215 to S219).

The motion of the finger has to detected real time and fed back to display. In the conventional technique, it is necessary to perform the process of determining the number of touch points (whether a touch at one point or a touch at two points) at very short time intervals, requiring a long processing time. Accordingly, in order to reflect a scroll or pinch operation on display real time, a high-performance CPU has to be installed in the equipment.

Moreover, as shown in step S209 in FIG. 24, if the number of touch points on the screen is two or more, a YES determination is made in step S209 and only a pinch operation or a rotate operation can be accepted. The conventional technique therefore has a problem of poor operability for users.

The present invention is made in order to solve the problem above. An object of the present invention is to provide an information processing apparatus that can simplify the processing, and to provide an information processing apparatus with good operability for users.

### SUMMARY OF THE INVENTION

In order to achieve the object above, an information processing apparatus according to an aspect of the present invention includes a detection unit capable of detecting a first touch position and a second touch position on a touch panel that are touched by a first object and a second object, respectively, a storage unit that stores the first touch position and the second touch position detected by the detection unit, holds a final touch position by the first object as the first touch position after a touch by the first object is released, and holds a final touch position by the second object as the second touch position after a touch by the second object is released, a calculation unit that calculates a position obtained by a predetermined rule from the first touch position and the second touch position stored by the storage unit, and a determination unit that determines whether an operation performed on the touch panel is an operation of moving a display content displayed on the touch panel, or an operation of rotating or changing a size of a display content displayed on the touch panel, based on whether the position calculated by the calculation unit is moved, a speed of movement, or an amount of movement.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing an example of an external configuration of an image processing apparatus in a first embodiment of the present invention.

FIG. 2 is a block diagram showing an example of a hardware configuration of the image processing apparatus.

FIG. 3 is a diagram showing a conceptual configuration of a program executed by a CPU.

FIG. 4 is a diagram showing an example of functional blocks implemented by the CPU activating a main program.

FIG. 5 is a flowchart showing an example of a process procedure performed by the CPU of the image processing apparatus.

FIG. 6 is a diagram showing an example of a preview image display screen that previews an image.

FIG. 7 is a diagram showing the relationship between display screens and operation events acceptable in each display screen.

FIG. 8 is a diagram for explaining a touch position on a touch panel (touch sensor) that is stored in an SRAM.

FIG. 9 is a flowchart showing a process executed by a CPU of an information processing apparatus in a first embodiment.

FIG. 10 is a flowchart showing a process in a conventional technique (FIG. 24) when the touch/release state is changed.

FIG. 11 is a flowchart showing a process in the first embodiment (FIG. 9) when the touch/release state is changed.

FIG. 12 is a flowchart showing a process in a conventional technique (FIG. 24) when the touch/release state is not changed.

FIG. 13 is a flowchart showing a process in the first embodiment (FIG. 9) when the touch/release state is not changed.

FIG. 14 is a diagram for explaining the relationship between the touch position and the midpoint in a time sequence in the first embodiment.

FIG. 15 is a flowchart showing a process executed by the CPU of the information processing apparatus in a second embodiment.

FIG. 16 is a flowchart showing a process executed by the CPU of the information processing apparatus in a third embodiment.

FIG. 17 is a diagram showing a specific example of a display content on the touch panel of the information processing apparatus in the third embodiment.

FIG. 18 is a flowchart showing a process executed by the CPU of the information processing apparatus in a fourth embodiment.

FIG. 19 is a flowchart showing a process executed by the CPU of the information processing apparatus in a fifth embodiment.

FIG. 20 is a flowchart showing a process executed by the CPU of the information processing apparatus in a sixth embodiment.

FIG. 21 is a flowchart showing a process executed by the CPU of the information processing apparatus in a seventh embodiment.

FIG. 22 is a flowchart showing a process executed by the CPU of the information processing apparatus in an eighth embodiment.

FIG. 23 is a flowchart showing a process executed by the CPU of the information processing apparatus in a ninth embodiment.

FIG. 24 is a flowchart partially showing a gesture determination process in a conventional technique.

### DESCRIPTION OF THE PREFERRED EMBODIMENTS

### First Embodiment

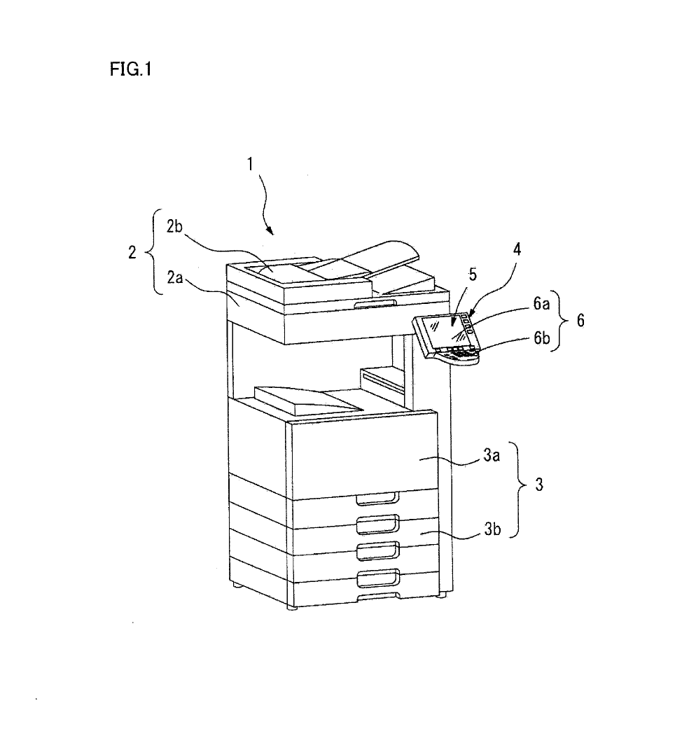

FIG. 1 is a diagram showing an example of an external configuration of an image processing apparatus 1 in a first embodiment of the present invention.

Image processing apparatus 1 is configured with an MFP (Multi-Function Peripheral) and has various functions including scan, print, copy, fax, network, and email transmission/reception functions. Image processing apparatus 1 executes a job designated by a user. Image processing apparatus 1 has a scanner 2 at the top of the apparatus, which operates when a scan job is executed. Scanner 2 is configured to include an image reading unit 2a for optically reading a document image and a document conveyance unit 2b for automatically conveying a document sheet by sheet to image reading unit 2a. Scanner 2 reads a document set by a user to generate image data. Image processing apparatus 1 also has a printer 3 at the bottom center of the apparatus body, which operates when a print job is executed. Printer 3 is configured to include an image Riming unit 3a and a paper feed conveyance unit 3b. Image forming unit 3a forms an image, for example, by an electrophotographic technique based on input image data and outputs the image. Paper feed conveyance unit 3b conveys a sheet material such as print paper sheet by sheet to image forming unit 3a. Printer 3 outputs print based on image data designated by a user.

On the front side of image processing apparatus 1, an operation panel 4 is provided, which functions as a user interface when a user uses image processing apparatus 1. Operation panel 4 is configured to include a display unit 5 for displaying a variety of information to the user and an operation unit 6 for the user to perform operation input. Display unit 5 is configured with, for example, a color liquid crystal display having a predetermined screen size and can display various images. Operation unit 6 is configured to include a touch sensor (touch panel) 6a arranged on the screen of display unit 5 and a plurality of push button-type operation keys 6b arranged around the screen of display unit 5. The user performs various input operations to operation unit 6 while looking at a display screen displayed on display unit 5 and thereby performs a setting operation on image processing apparatus 1 for executing a job or instructing image processing apparatus 1 to execute a job.

Touch sensor 6a arranged on the screen of display unit 5 can detect not only a single touch operation by the user but also a multi-touch operation. The single touch operation refers to an operation of touching one point on a display screen of display unit 5 and includes, for example, single-tap, double-tap, scroll, and drag operations. The multi-touch operation refers to an operation of touching a plurality of points simultaneously on a display screen of display unit 5 and includes, for example, pinch operations including pinch-in, pinch-out, and rotate. When at least one point on a display screen of display unit 5 is touched, touch sensor 6a can specify the touch position and thereafter can detect a release from the touch state and a movement of the touch position. The user thus can make a job setting, for example, by performing various gesture operations on a display screen of display unit 5.

Operation keys 6b arranged around the screen of display unit 5 are configured, for example, with a ten-key pad with numbers 0 to 9. Operation keys 6b merely detect a push operation by the user.

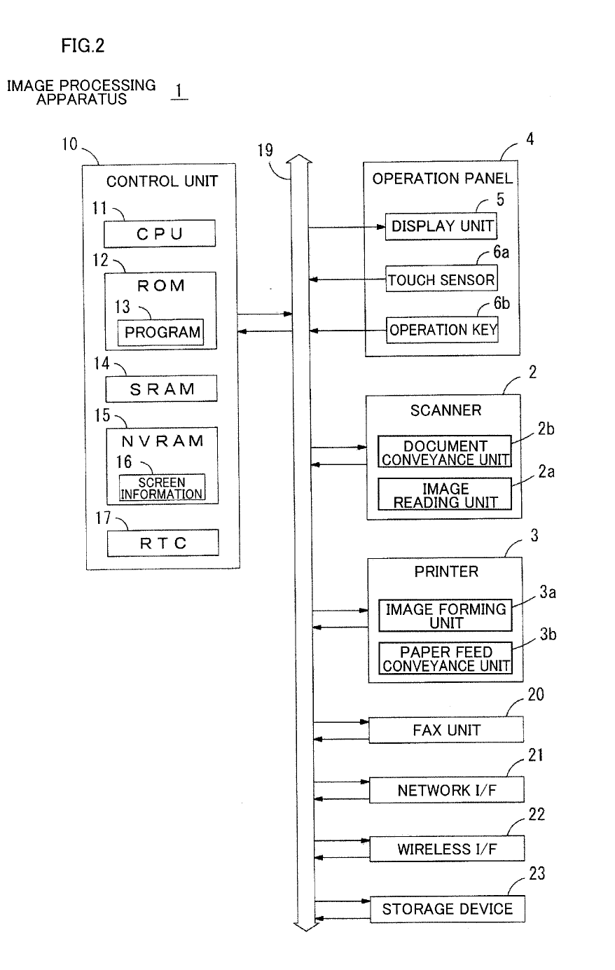

FIG. 2 is a block diagram showing an example of a hardware configuration of image processing apparatus 1.

Image processing apparatus 1 includes scanner 2, printer 3, and operation panel 4 as described above as well as a control unit 10, a fax unit 20, a network interface 21, a wireless interface 22, and a storage device 23 as shown in FIG. 2. Those units of image processing apparatus 1 can input/output data from/to each other through a data bus 19.

Control unit 10 centrally controls operation panel 4, scanner 2, printer 3, FAX unit 20, network interface 21, wireless interface 22, and storage device 23 shown in FIG. 2. FAX unit 20 transmits/receives FAX data through a not-shown public telephone circuit. Network interface 21 is an interface for connecting image processing apparatus 1 to a network such as a LAN (Local Area Network). Wireless interface 22 is an interface for wirelessly communicating with an external device, for example, by NFC (Near Field Communication). Storage device 23 is nonvolatile storage means configured with, for example, a hard disk drive (HDD) or a solid state drive (SSD). Storage device 23 can temporarily store image data received through a network and image data generated by scanner 2.

As shown in FIG. 2, control unit 10 is configured to include a CPU 11, a ROM 12, an SRAM 14, an NVRAM 15, and an RTC 17. CPU 11 reads out a program 13 stored in ROM 12 for execution in response to power-on of image processing apparatus 1. Control unit 10 then starts a control operation for each unit as described above. In particular, CPU 11 is a main unit that controls operation in image processing apparatus 1. CPU 11 not only controls a job execution operation but also controls the operation of operation panel 4 functioning as a user interface. Specifically, CPU 11 performs control of changing display screens appearing on display unit 5 of operation panel 4 and, in addition, when a user's input operation is detected by touch sensor 6a and operation keys 6b, specifies what operation event is the input operation, and executes control corresponding to the specified operation event. The operation event is an event produced by a user's input operation. For input operations to touch sensor 6a, there are a plurality of operation events, for example, including single-tap, double-tap, long-tap, scroll, drag, and pinch. The control corresponding to the operation events includes, for example, control of switching display screens, control of starting execution of a job, and control of stopping execution of a job. The operation of CPU 11 as described above will be described in detail later.

SRAM 14 is a memory that provides a working storage area for CPU 11. SRAM 14 stores, for example, temporary data produced by execution of program 13 by CPU 11.

NVRAM 15 is a battery backed-up nonvolatile memory and stores setting values and information in image processing apparatus 1. Screen information 16 is stored in advance in NVRAM 15 as shown in FIG. 2. Screen information 16 is configured with information related to a plurality of display screens to be displayed on display unit 5 of operation panel 4. Screen information 16 of each display screen includes a variety of images such as icon images and button images allowing the user to perform a tap operation. That is, a screen configuration that allows the user to perform gesture operations is defined in screen information 16. A plurality of display screens to be displayed on display unit 5 have respective different screen configurations. Accordingly, the operation events that can be accepted when the user performs a gesture operation on touch sensor 6a vary.

RTC 17 is a real time clock that is a clock circuit keep counting time.

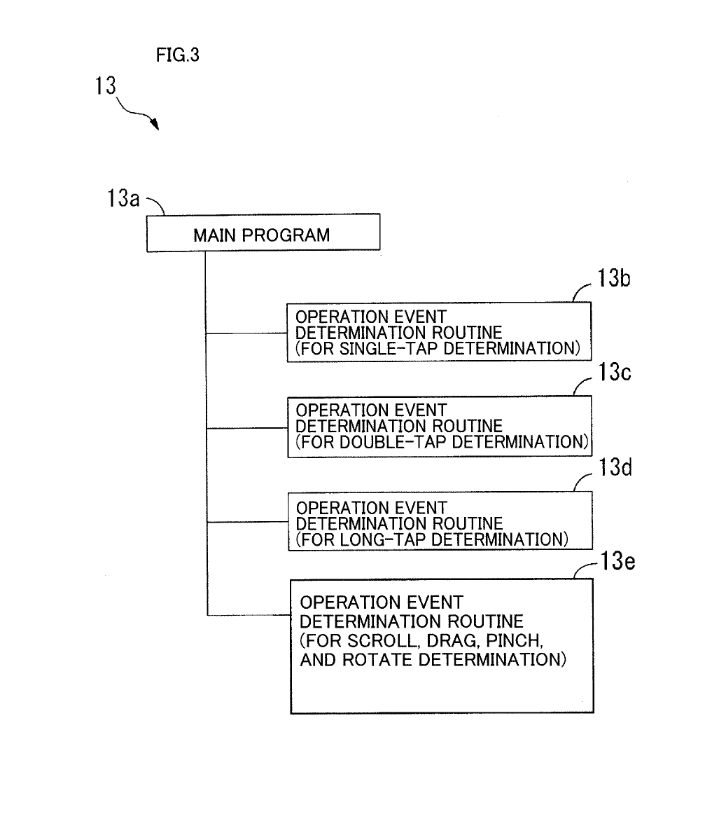

FIG. 3 is a diagram showing a conceptual configuration of program 13 executed by CPU 11.

Program 13 is configured to include a main program 13a and a plurality of operation event determination routines 13b, 13c, 13d, and 13e prepared as subroutines of main program 13a. Main program 13a is automatically read out and activated by CPU 11 at power-on of image processing apparatus 1. A plurality of operation event determination routines 13b to 13e are subroutines for specifying whether an input operation (gesture operation) by the user is single-tap, double-tap, or long-tap, or any one of scroll (flick), drag, pinch, and rotate when touch sensor 6a detects the input operation. Operation event determination routines 13b to 13e are prepared as individual subroutines because the specific content and procedure of a specific determination process varies among operation events to be specified. In the present embodiment, when touch sensor 6a detects an input operation by the user, CPU 11 activates only a necessary operation event determination routine from among a plurality of operation event determination routines 13b to 13e. An operation event corresponding to the input operation is thus specified efficiently. Specific process contents of CPU 11 will be described below.

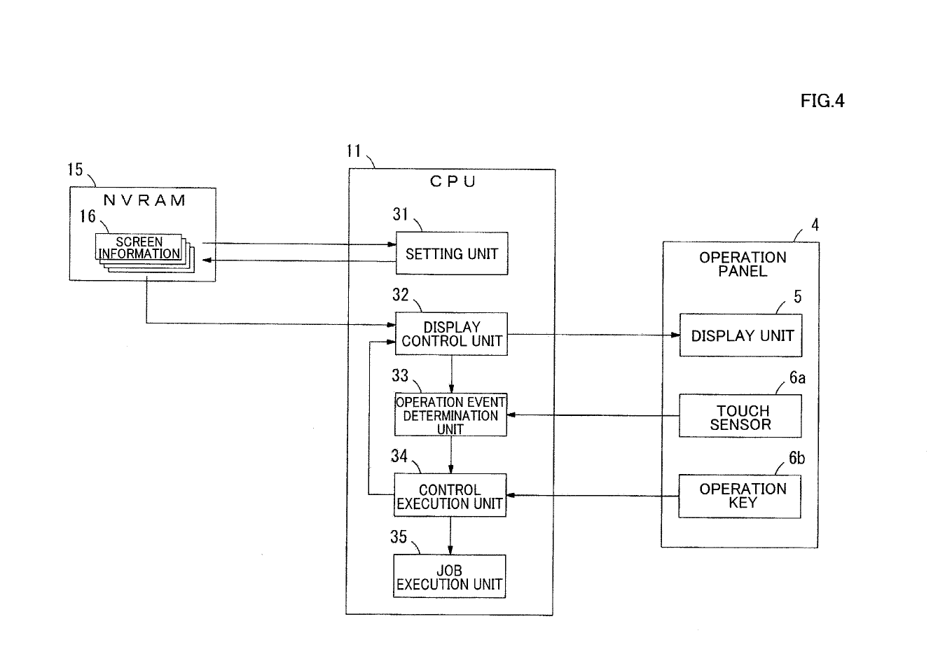

FIG. 4 is a diagram showing an example of functional blocks implemented by CPU 11 activating main program 13a.

As shown in FIG. 4, CPU 11 executes main program 13a thereby to function as a setting unit 31, a display control unit 32, an operation event determination unit 33, a control execution unit 34, and a job execution unit 35.

Setting unit 31 is a processing unit that sets an operation event to be detected based on a user's input operation, from among a plurality of operation events, in association with each display screen to be displayed on display unit 5. That is, setting unit 31 specifies an operation event acceptable in each display screen by reading out and analyzing screen information 16 stored in NVRAM 15. Setting unit 31 then associates the specified operation event with each display screen in advance. For example, setting unit 31 sets an operation event in association with each display screen by adding information related to the specified operation event to screen information 16 of each display screen. Setting unit 31 associates at least one of a plurality of operation events including single-tap, double-tap, long-tap, scroll, drag, and pitch with one display screen. For example, in a case of a display screen that can accept all the operation events, setting unit 31 associates all of the operation events.

The information that associates operation events may be added in advance at a timing when screen information 16 is stored into NVRAM 15 at a time of shipment of image processing apparatus 1. Screen information 16 stored in NVRAM 15 may be updated even after the shipment of image processing apparatus 1, for example, due to addition of an optional function, installation of a new application program, and customization of a display screen. When screen information 16 is updated, a screen configuration of each display screen is changed. When screen information 16 is updated, an operation event that cannot be accepted before then may become acceptable after updating of screen information 16. Setting unit 31 therefore functions at the beginning in conjunction with activation of main program 13a by CPU 11. Setting unit 31 sets an operation event to be detected based on a user's input operation from among a plurality of operation events in association with each display screen while a startup process of image processing apparatus 1 is being performed.

Display control unit 32 reads out screen information 16 stored in NVRAM 15 and selects one display screen from among a plurality of display screens for output to display unit 5, thereby to display the selected display screen on display unit 5. Upon completion of the startup process of image processing apparatus 1, display control unit 32 selects an initial screen from among a plurality of display screens and displays the initial screen on display unit 5. Display control unit 32 thereafter successively updates display screens on display unit 5 based on a screen update instruction from control execution unit 34.

Operation event determination unit 33 is a processing unit that specifies an operation event corresponding to an input operation when touch sensor 6a of operation panel 4 detects the input operation by the user on a display screen. Operation event determination unit 33 is one of functions implemented by main program 13a. Operation event determination unit 33 specifies an operation event associated in advance with a display screen currently appearing on display unit 5 at a timing when a user's input operation is detected by touch sensor 6a. Operation event determination unit 33 specifies an operation event corresponding to the user's input operation by activating only the operation event determination routine that corresponds to the specified operation event. That is, when a user's input operation on a display screen is detected, only the operation event determination routine that corresponds to the operation event associated with the display screen by setting unit 31 is activated from among a plurality of operation event determination routines 13b to 13e, in order to determine only the operation event that can be accepted in the display screen. Here, a plurality of operation events may be associated with a display screen. This is the case, for example, where a display screen appearing on display unit 5 can accept three operation events, namely, single-tap, double-tap, and scroll. In such a case, operation event determination unit 33 successively activates the operation event determination routines corresponding to those operation events, thereby specifying the operation event corresponding to the user's input operation. In this manner, when some input operation is performed by the user on touch sensor 6a, operation event determination unit 33 activates only the operation event determination routine that corresponds to the operation event acceptable by the display screen appearing on display unit 5 at that timing, rather than activating all the operation event determination routines 13b to 13e every time. Accordingly, the operation event corresponding to the user's input operation can be specified efficiently without activating unnecessary determination routines.

When operation event determination unit 33 can specify an operation event corresponding to the user's input operation by activating only the necessary operation event determination routine, the specified operation event is output to control execution unit 34. Even when only the necessary operation event determination routine is activated as described above, an operation event corresponding to the user's input operation cannot be specified in some cases. For example, it is assumed that the user performs an operation such as long-tap on a display screen that can accept three operation events, namely, single-tap, double-tap, and scroll. In this case, an operation event corresponding to the user's input operation cannot be specified even by activating operation event determination routines 13b, 13c, and 13e corresponding to three operation events of single-tap, double-tap, and scroll, respectively. In this case, operation event determination unit 33 does not perform an output process to control execution unit 34.

Control execution unit 34 is a processing unit that executes control based on an operation performed by the user on operation panel 4. When the user performs a gesture operation on touch sensor 6a, control execution unit 34 inputs the operation event specified by operation event determination unit 33 as described above and executes control based on that operation event. By contrast, when the user performs an operation on operation key 6b, control execution unit 34 receives an operation signal directly from that operation key 6b, specifies the operation (operation event) performed by the user based on the operation signal, and executes control based on the specified operation. Examples of the control executed by control execution unit 34 based on the user's input operation include control of updating a display screen appearing on display unit 5 and control of starting or stopping execution of a job. Accordingly, control execution unit 34 is configured to control display control unit 32 and job execution unit 35 as shown in FIG. 4. Specifically, when a display screen is to be updated based on the input operation by the user, control execution unit 34 instructs display control unit 32 to update the screen. When execution of a job is to be started or stopped, control execution unit 34 instructs job execution unit 35 to start or stop execution of a job. Accordingly, display control unit 32 updates the display screen appearing on display unit 5 based on an instruction from control execution unit 34. Job execution unit 35 starts execution of a job or stops a job already being executed, based on an instruction from control execution unit 34. The control executed by control execution unit 34 may include control other than those described above.

Job execution unit 35 controls execution of a job specified by the user by controlling the operation of each unit in image processing apparatus 1. Job execution unit 35 is resident in CPU 11 to centrally control the operation of each unit while a job is being executed in image processing apparatus 1.

Specific process procedures performed in CPU 11 having the functional configuration as described above will now be described.

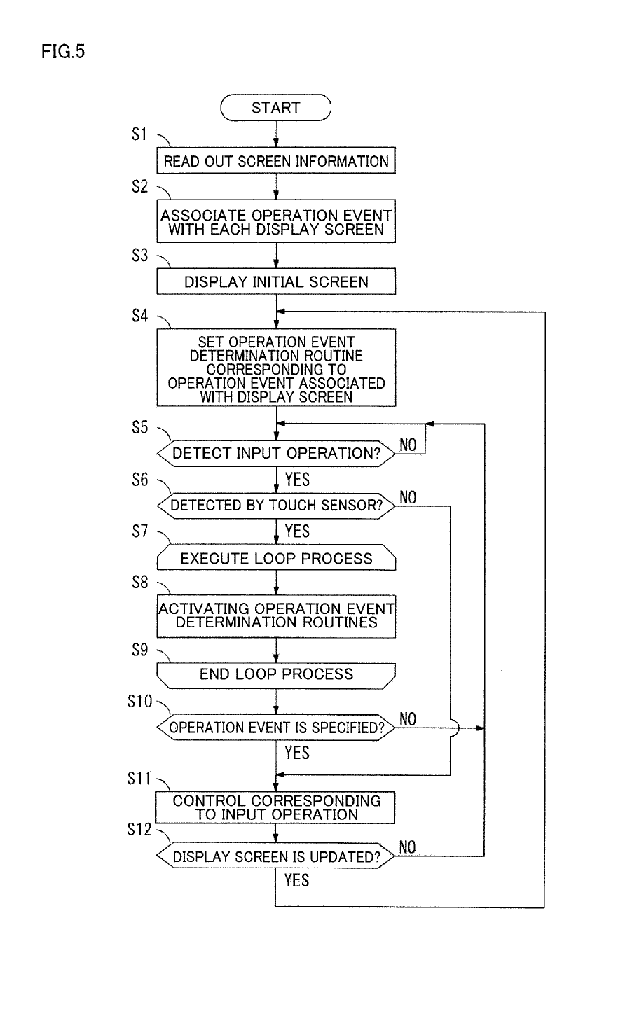

FIG. 5 is a flowchart showing an example of a process procedure performed by CPU 11 of image processing apparatus 1.

This process is started when image processing apparatus 1 is powered on and CPU 11 activates main program 13a included in program 13.

First, CPU 11 activates main program 13a, then reads out screen information 16 (step S1), and associates an operation event with each display screen based on screen information 16 (step S2). When the association of all the operation events with each display screen is completed, CPU 11 displays an initial screen on display unit 5 of operation panel 4 (step S3). When a display screen appears on display unit 5 in this manner, CPU 11 sets an operation event determination routine corresponding to the operation event associated with the display screen (step S4). This brings about a state in which an operation event determination routine that corresponds to an operation event acceptable by the display screen currently appearing on display unit 5 is prepared.

CPU 11 enters the standby state until an input operation is detected by one of touch sensor 6a and operation key 6b (step S5). When an input operation by the user is detected (YES in step S5), CPU 11 determines whether the input operation is the one detected by touch sensor 6a (step S6). If the input operation is the one detected by touch sensor 6a (YES in step S6), CPU 11 executes a loop process for specifying an operation event corresponding to the user's input operation by successively activating the operation event determination routines preset in step S4 (steps S7, S8, S9). In this loop process (steps S7, S8, S9), all of operation event determination routines 13b to 13e included in program 13 are not activated in order. In this loop process (steps S7, S8, S9), only the operation event determination routine set in step S4 that corresponds to the operation event acceptable in the display screen currently appearing is activated. In a case where a plurality of operation event determination routines are successively activated in the loop process, the loop process is terminated at a timing when an operation event corresponding to the user's input operation is specified in any one of the operation event determination routines. In other words, in this loop process (steps S7, S8, S9), not all of the operation event determination routines set in step S4 are always activated. In this loop process (steps S7, S8, S9), if an operation event corresponding to the user's input operation can be specified halfway before all are activated, the loop process is terminated without activating the operation event determination routines that are to be activated subsequently.

When the loop process (steps S7, S8, S9) is terminated, CPU 11 determines whether an operation event can be specified through the loop process (steps S7, S8, S9) (step S10). The determination in step S10 is required because the user may perform a gesture operation that is not acceptable on the display screen currently appearing. If an operation event corresponding to the user's input operation cannot be specified (NO in step S10), CPU 11 returns to the standby state (step S5) without proceeding to the subsequent process (step S11) until an input operation by the user is detected again. By contrast, if an operation event corresponding to the user's input operation can be specified in the loop process (steps S7, S8, S9) (YES in step S10), the process by CPU 11 proceeds to the next step S11.

If an input operation by the user is detected (YES in step S5) and the input operation is the one detected by operation key 6b (NO in step S6), the process by CPU 11 also proceeds to step S11. That is, when the user operates operation key 6b, the operation event can be specified by the operation signal, and, therefore, the process proceeds to the process in the case where an operation event can be specified (step S11).

When an operation event corresponding to the user's input operation is specified, CPU 11 executes control corresponding to the input operation (step S11). Specifically, as described above, control of updating the display screen on display unit 5, job execution control, or any other control is performed. CPU 11 then determines whether the display screen appearing on display unit 5 is updated through execution of the control in step S11 (step S12). As a result, if it is determined that the display screen is updated (YES in step S12), the process by CPU 11 returns to step S4. Specifically, CPU 11 sets an operation event determination routine corresponding to an operation event associated with the updated display screen (step S4). By contrast, if the display screen is not updated (NO in step S12), the process by CPU 11 returns to step S5. Specifically, CPU 11 enters the standby state until an input operation by the user is detected again (step S5). CPU 11 then repeats the process above.

By performing the process as described above, CPU 11 can perform a process corresponding to the operation performed by the user on operation panel 4. In particular, the process as described above may be performed concurrently during execution of a job, and when the user performs a gesture operation on the display screen, the required minimum number of operation event determination routines are activated in order to specify only the operation event that can be accepted on the display screen. Therefore, the operation event corresponding to the user's gesture operation can be specified efficiently without activating unnecessary operation event determination routines in execution of a job.

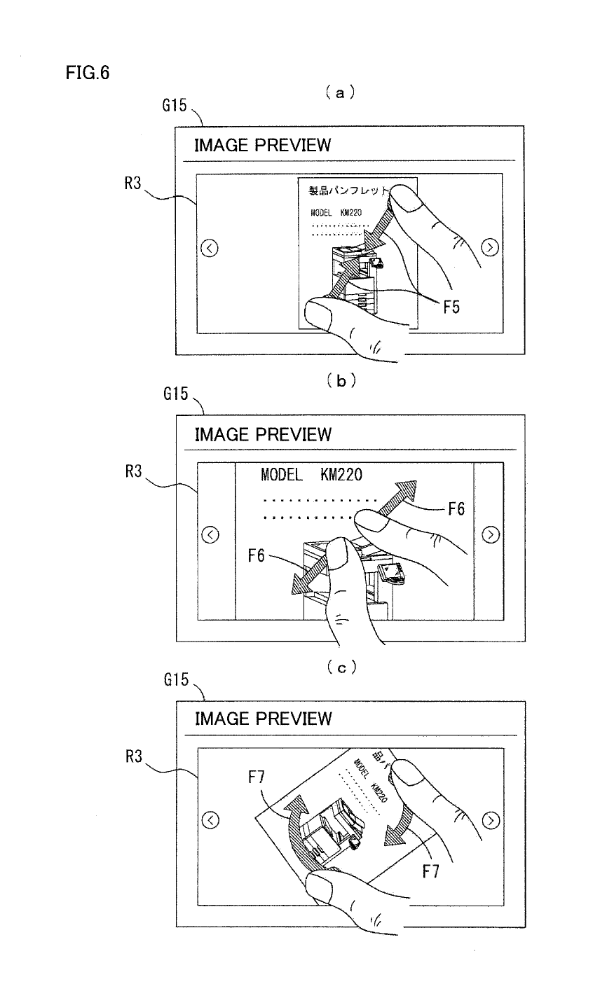

FIG. 6 is a diagram showing an example of a preview image display screen G15 that previews an image.

Preview image display screen G15 is displayed on display unit 5 of operation panel 4. Preview image display screen G15 has a screen configuration including a preview area R3 for previewing an image selected by the user. The operations that can be performed by the user on preview image display screen G15 include a pinch operation for reducing or enlarging a preview image and a rotate operation for rotating a preview image. The pinch operation includes a pinch-in operation for reducing a preview image and a pinch-out operation for enlarging a preview image. The pinch-in operation is an operation of moving two points of a preview image displayed in preview area R3 so as to reduce the distance therebetween with two fingers touching the two points, as shown by an arrow F5 in FIG. 6(a). This pinch-in operation allows the preview image displayed in preview area R3 to be displayed in a reduced size. The pinch-out operation is an operation of moving two points of a preview image displayed in preview area R3 so as to increase the distance therebetween with two fingers touching the two points, as shown by an arrow F6 in FIG. 6(b). This pinch-out operation allows the preview image displayed in preview area R3 to be displayed in an enlarged size. The rotate operation is an operation of moving two points of a preview image displayed in preview area R3 so as to rotate the position between the two points with two fingers touching the two points, as shown by an arrow F7 in FIG. 6(c). This rotation operation allows a preview image displayed in preview area R3 to be displayed in a rotated state.

In preview image display screen G15, not only when a pinch-out operation is performed but also when a double-tap operation is performed on a point in a preview image displayed in preview area R3, a process of displaying the preview image in an enlarged size is performed with the point at the center. In preview image display screen G15, when a preview image is displayed in an enlarged size and the entire image cannot be displayed in preview area R3, a drag operation can be accepted. In preview image display screen G15, when a drag operation is performed, the enlarged display portion is moved and displayed. In preview image display screen G15, a scroll (flick) operation for switching the displayed image to the next (or previous) image can be accepted.

In this manner, preview image display screen G15 shown in FIG. 6 has a screen configuration that can accept four operation events, namely, scroll (flick), drag, double-tap, and pinch, and does not accept the other operation events. Accordingly, setting unit 31 sets four operation events of scroll (flick), drag, double-tap, and pinch in association with preview image display screen G15 shown in FIG. 6.

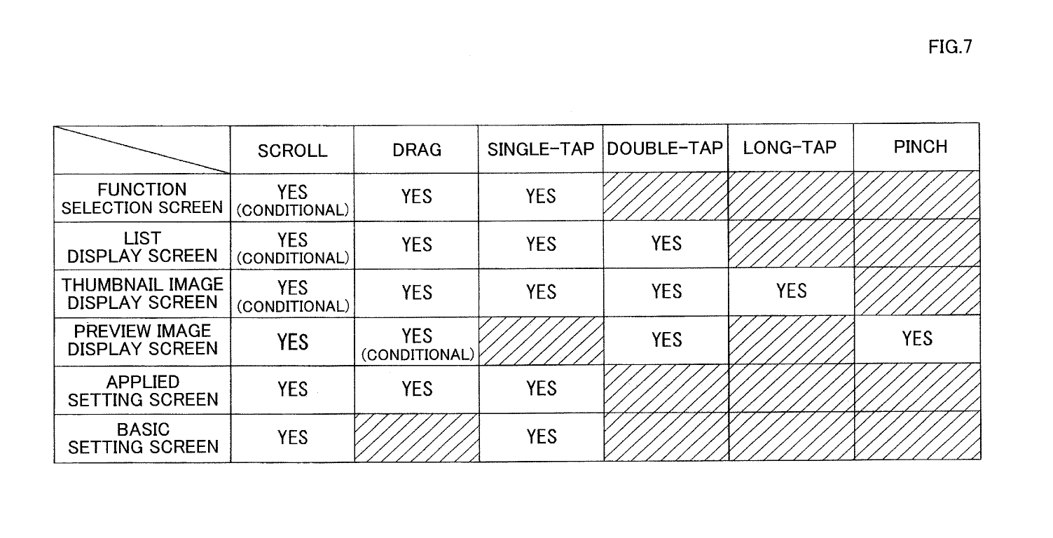

FIG. 7 is a diagram showing the relationship between display screens and operation events acceptable in each display screen.

In FIG. 7, an operation event acceptable in each display screen is denoted by “YES”, and an operation event not acceptable is hatched. As shown in FIG. 7, there are various kinds of display screens to be displayed on display unit 5 of operation panel 4, and acceptable operation events vary among display screens. Then, as described above, setting unit 31 specifies an acceptable operation event and sets an operation event to be detected based on a user's input operation in association with each display screen. That is, the operation events associated with each display screen by setting unit 31 are the same as shown in FIG. 7.

In FIG. 7, a drag operation is conditionally acceptable in a preview image. That is, in this display screen, a drag operation is not an operation event that is always acceptable but is acceptable when a particular condition is met. For example, as shown in FIG. 6(h) above, when a preview image is displayed in an enlarged size in preview area R3 of preview image display screen G15, a drag operation for moving the enlarged display portion is acceptable. However, it is not necessary to move the enlarged display portion when a preview image is not displayed in an enlarged size. In such a state, therefore, a drag operation for moving the enlarged display portion is not acceptable in preview image display screen G15.

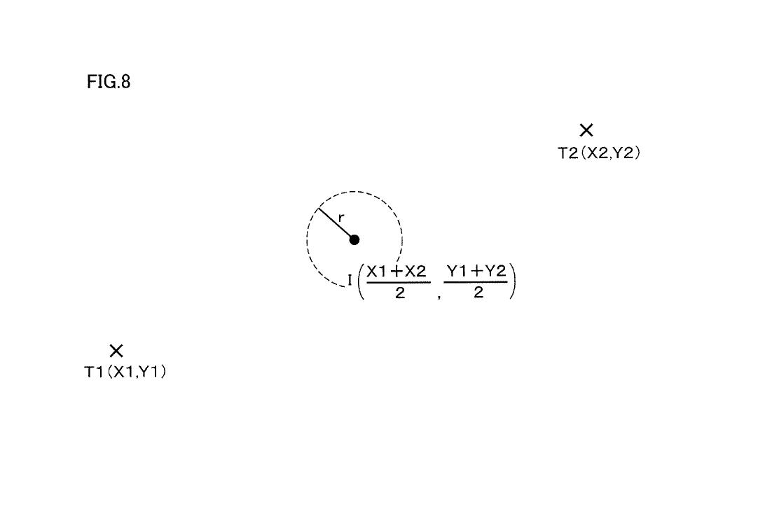

FIG. 8 is a diagram for explaining a touch position on the touch panel (touch sensor 6a) that is stored in SRAM 14.

Coordinates T1 (X1, Y1) of a touch position by a first object (for example, the fingertip of a thumb) and coordinates T2 (X2, Y2) of a touch position by a second object (for example, the fingertip of an index finger) on the touch panel (touch sensor 6a) are detected every sampling period (or real-time) and recorded in SRAM 14. Before touching, initial coordinate values (A, A) are stored for T1 (X1, Y1) and T2 (X2, Y2).

When the first and second objects are moved on the touch panel while being touched, coordinates T1 (X1, Y1) and coordinates T2 (X2, Y2) are changed every sampling period (or real-time).

After the touch by the first object is released (after the first object is lifted from the touch panel), the coordinates of the final touch position by the first object is held as T1 (X1, Y1). Similarly, after the touch by the second object is released (after the second object is lifted from the touch panel), the coordinates of the final touch position by the second object is held as T2 (X2, Y2).

CPU 11 calculates a position (coordinates) I obtained by a predetermined rule from coordinates T1 (X1, Y1) and coordinates T2 (X2, Y2). Here, a predetermined rule is to obtain a midpoint between coordinates T1 (X1, Y1) and coordinates T2 (X2, Y2). That is, coordinates I are calculated by ((X1+X2)/2, (Y1+Y2)/2).

The predetermined rule is a rule for obtaining a position from coordinates T1 (X1, Y1) and coordinates T2 (X2, Y2), and coordinates I may be obtained not by the midpoint but by the following expression:

coordinates I=((X1+X2),(Y1+Y2)); (a)

coordinates I=((X1+X2)×a,(Y1+Y2)×a) (where a is any given number that is not zero (weight coefficient). (b)

Coordinates I represent a point having the following features. That is, coordinates I represent a point that is moved when a scroll operation or a drag operation is being performed. Otherwise, coordinates I represent a point where when a scroll operation or a drag operation is being performed, the speed of the movement or the amount of the movement within a predetermined time is equal to or greater than a threshold value. On the other hand, when a pinch-in operation, a pinch-out operation, or a rotate operation is being performed, coordinates I do not move theoretically (considering an error, when a pinch-in operation, a pinch-out operation, or a rotate operation is being performed, the speed of the movement of coordinates I or the amount of the movement within a predetermined time is smaller than a threshold value). In FIG. 8, the threshold value is represented by “r”. If the velocity vector of the movement of coordinates I or the amount of the movement within a predetermined time falls within the dotted circle, it can be determined that a pinch-in operation, a pinch-out operation, or a rotate operation is performed. If the velocity vector of the movement of coordinates I or the amount of the movement within a predetermined time falls on the dotted circle or out of the dotted circle, it can be determined that a scroll operation or a drag operation is performed.

Using these features of coordinates I, the information processing apparatus 1 in the present embodiment determines whether the operation by the user is a scroll operation or a drag operation, otherwise a pinch-in operation, a pinch-out operation, or a rotate operation, based on the movement of coordinates I.

According to the present embodiment, after the touch by the first object is released, the coordinates of the final touch position by the first object is held as T1 (X1, Y1). After the touch by the second object is released, the coordinates of the final touch position by the second object is held as T2 (X2, Y2). Accordingly, coordinates I can be calculated even in a state in which a touch is made with one finger. Therefore, it can be determined that a scroll operation or a drag operation is performed based on a state of the movement of coordinates I.

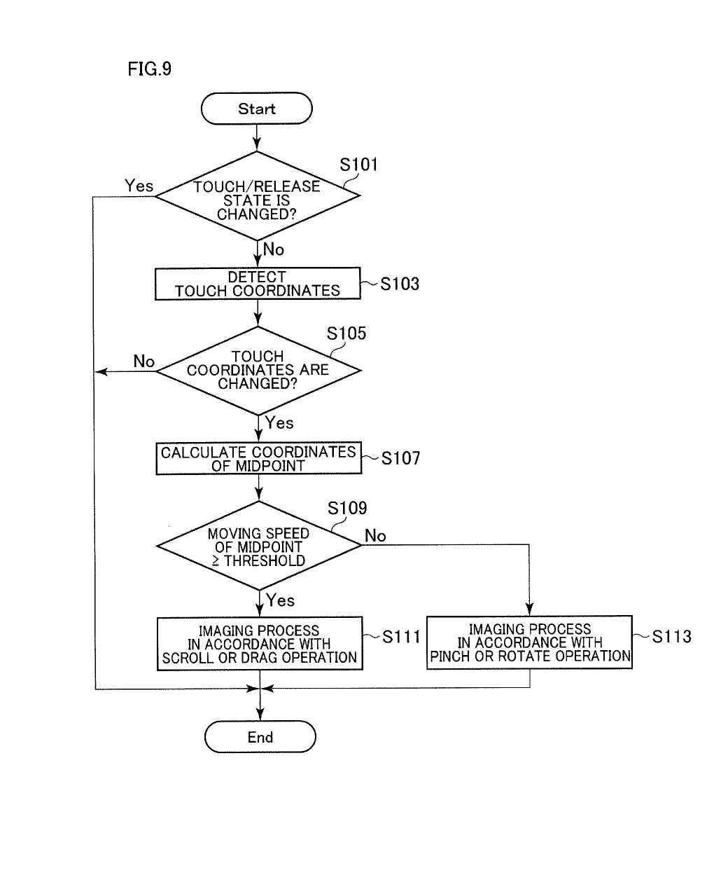

FIG. 9 is a flowchart showing a process executed by CPU 11 of the information processing apparatus in the first embodiment.

This process is implemented by CPU 11 executing the program of operation event determination routine 13e (determination for scroll, drag, pinch, and rotate) in FIG. 3. The process in the flowchart in FIG. 9 is repeatedly executed at predetermined time intervals (for example, every 20 milliseconds). The predetermined time interval is the sampling period for touch coordinates and the calculation period for coordinates I.

Referring to FIG. 9, in step S101, it is determined whether the touch/release state of the touch panel is changed. Here, the determination is YES if

(A) a state in which no touch is made changes to a state in which one or more points are touched;

(B) a state in which one or more points are touched changes to a state in which no touch is made; or

(C) the number of touched points is changed.

If YES in step S101, the process in the present period is terminated. If NO in step S101, in step S103, the touch coordinates (position) on the touch panel are detected. When a plurality of points are touched, all of the touch coordinates are detected. The touch coordinates are stored into SRAM 14. As described with reference to FIG. 8, after the touch is released, the final touch coordinates are held.

In step S105, it is determined whether there is any change in touch coordinates from the previous period. This is to determine whether any one of the touch positions is moved.

If NO in step S105, the process in the present period is terminated. If YES in step S105, in step S107, coordinates I (for example, the midpoint) are calculated.

In step S109, it is determined whether the moving speed of coordinates I is equal to or greater than a threshold value. In step S109, it may be determined whether coordinates I are moved, or whether the amount of the movement of coordinates I within a predetermined time (for example, from the previous sampling period to the present time) is equal to or greater than a threshold value.

If YES in step S109, in step S111, it is determined that the operation by the user is a scroll operation or a drag operation, and a screen imaging process in accordance with a scroll operation or a drag operation is performed. The determination as to whether the operation is a scroll operation or a drag operation can be made, for example, based on the display content of the screen, the display content at the touch position, and the time interval from when a touch is made to when the touch position is moved.

If NO in step S109, in step S113, it is determined that the operation by the user is a pinch-in operation, a pinch-out operation, or a rotate operation, and a screen image process in accordance with a pinch-in operation, a pinch-out operation, or a rotate operation is performed. The determination as to whether the operation is a rotate operation, a pinch-in operation, or a pinch-out operation is made based on the direction in which the touch position is moved. Specifically, if the touch positions at two points are rotated in a predetermined direction about the midpoint, it is determined that the operation is a rotate operation. If the touch positions at two points are moved in a direction toward the midpoint, it is determined that the operation is a pinch-in operation. If the touch positions at two points are moved in a direction away from the midpoint, it is determined that the operation is a pinch-out operation.

The effects of the present embodiment will now be described.

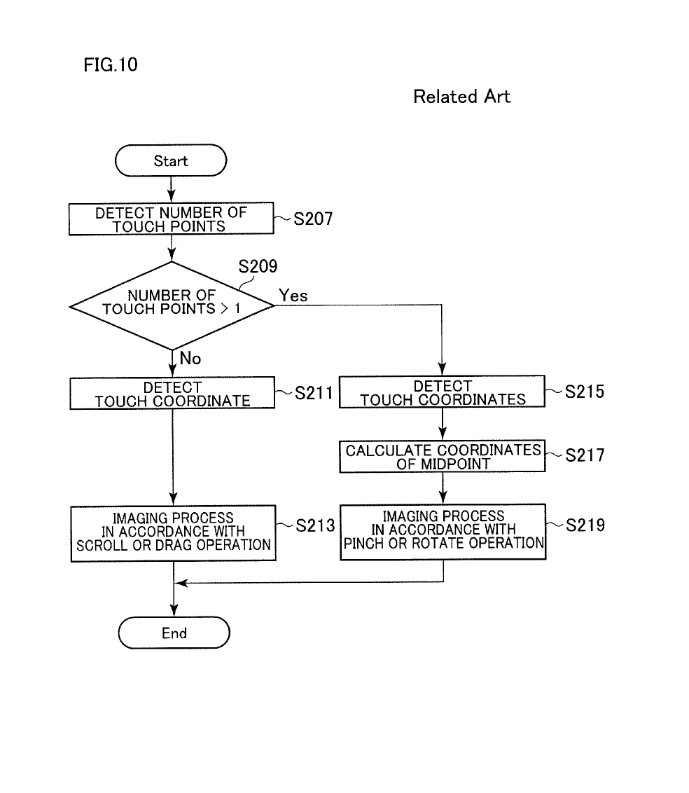

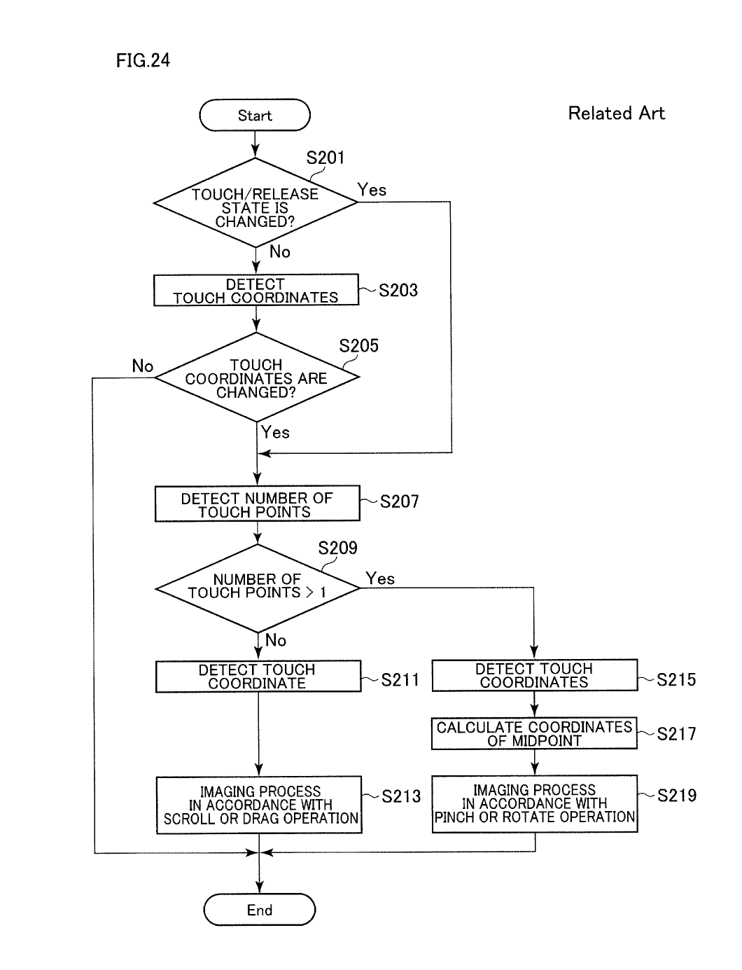

FIG. 10 is a flowchart showing a process in a conventional technique (FIG. 24) when the touch/release state is changed.

As described with reference to FIG. 24, when the touch/release state is changed, a YES determination is made in step S201, and the process from step S207 is executed. Therefore, substantially, the number of touch points is acquired (S207), and it is determined whether the number of touch points is one or two (S209), as illustrated in FIG. 10. After that, the touch coordinates are detected (S211, S215), and an image process in accordance with the number of touch points is performed (S213, S219). For a pinch operation and a rotate operation, a process of calculating the midpoint between the touch positions at two points (S217) is performed.

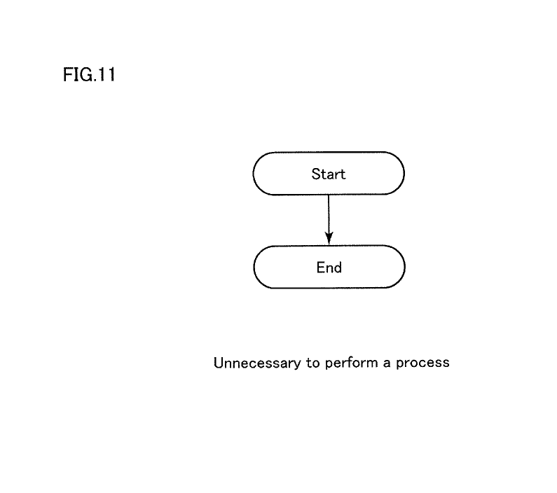

FIG. 11 is a flowchart showing a process in the first embodiment (FIG. 9) when the touch/release state is changed.

As described with reference to FIG. 9, when the touch/release state is changed, a YES determination is made in step S101, and the process ends. It is therefore unnecessary to perform a substantial process as shown in FIG. 11. As described above, the present embodiment can significantly reduce the processing when the touch/release state is changed.

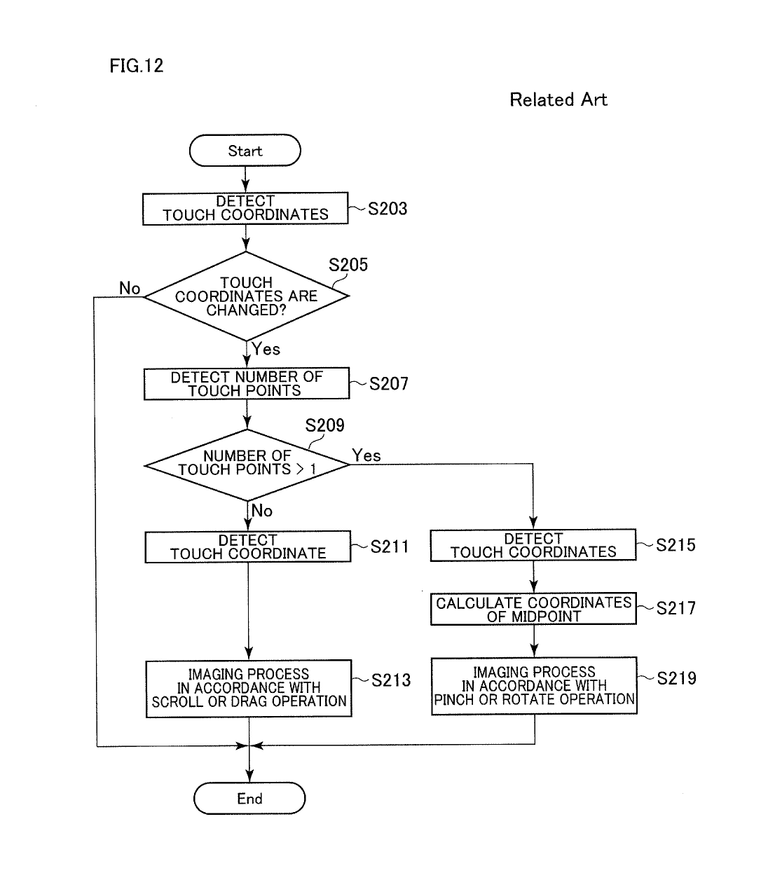

FIG. 12 is a flowchart showing a process in a conventional technique (FIG. 24) when the touch/release state is not changed.

As described with reference to FIG. 24, when there is no change in the touch/release state, a NO determination is made in step S201, and the process from step S203 is executed. Therefore, substantially, the touch coordinates are detected (S203), and the number of touch points is acquired (S207) if the coordinates are changed, as illustrated in FIG. 12. It is determined whether the number of touch points is one or two (S209), followed by detection of the touch coordinates (S211, S215) and an imaging process in accordance with the number of touch points (S213, S219). For a pinch operation and a rotate operation, a process of calculating the midpoint between the touch positions at two points is performed (S217).

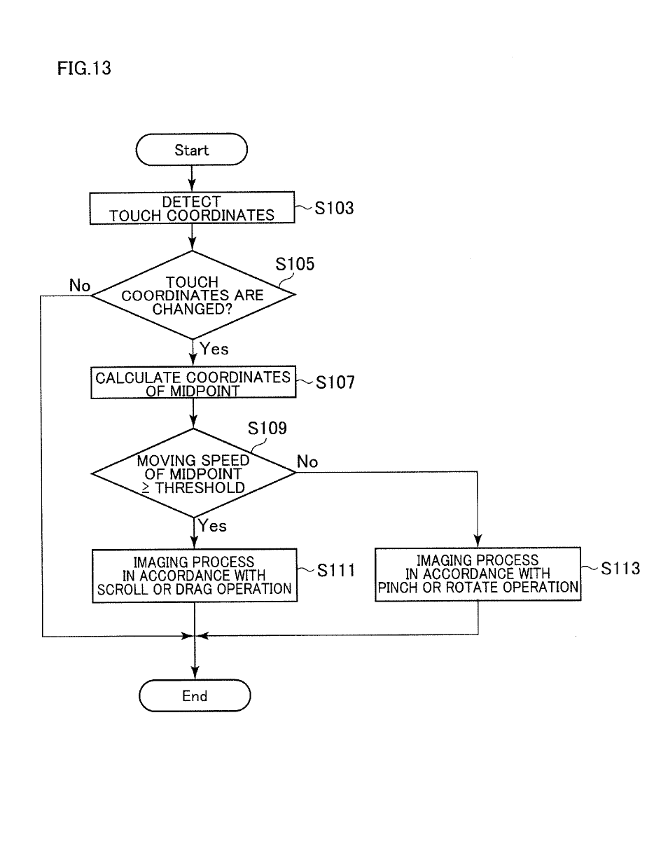

FIG. 13 is a flowchart showing a process in the first embodiment (FIG. 9) when the touch/release state is not changed.

As described with reference to FIG. 9, when there is no change in the touch/release state, a NO determination is made in step S101, and the process from step S103 is executed. Specifically, the touch coordinates are detected (S103), and the midpoint (coordinates I in FIG. 8) are calculated (S107) if the touch coordinates are changed (YES in S105). Based on a state of the movement of coordinates I (S109), a screen imaging process in accordance with a scroll operation or a drag operation (S111) or a screen imaging process in accordance with a pinch-in operation, a pinch-out operation, or a rotate operation (S113) is performed.

In FIG. 13, the process of acquiring and determining the number of touch points (S207, S209 in FIG. 12) can be eliminated. The determination in step S109 can be performed using the value of the midpoint (coordinates I) that has to be acquired in a case of a pinch-in operation, a pinch-out operation, or a rotate operation. Accordingly, the present embodiment can significantly reduce the processing in the case where there is no change in the touch/release state.

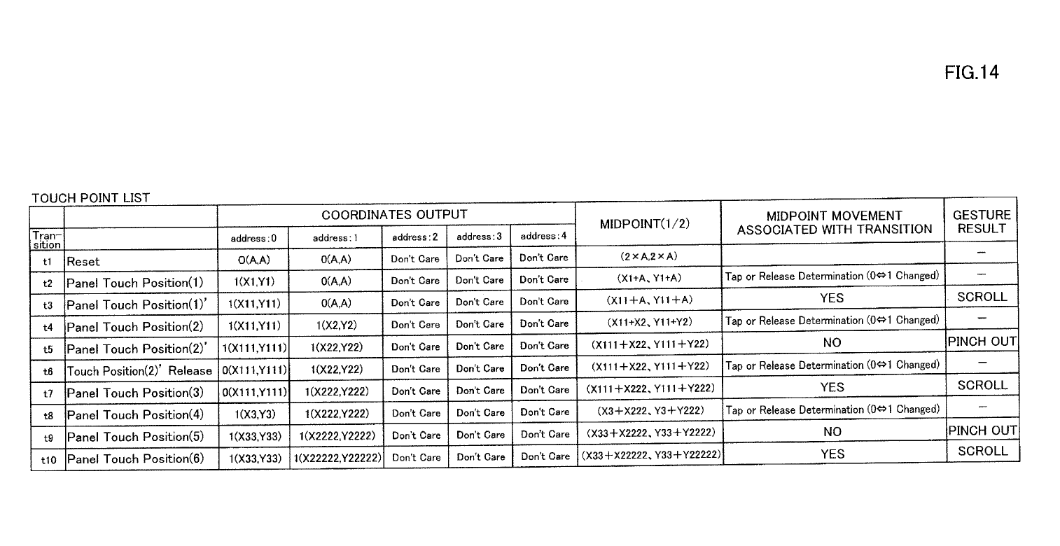

FIG. 14 is a diagram for explaining the relationship between the touch position and the midpoint in a time sequence in the first embodiment.

Referring to FIG. 14, at time t1, no touch is made on the touch panel, and the coordinates (A, A) as initial values are recorded both in coordinates T1 (X1, Y1) (address: 0 in the figure) and coordinates T2 (X2, Y2) (address: 1 in the figure). In the present embodiment, a touch at one point or two points is detected, and, therefore, only address: 0 and address: 1 are used in the figure. In a case where a touch at three or more points is detected, coordinates T3 (X3, Y3) (the touch position at the third point) and the subsequent coordinates are recorded in address: 2 and the subsequent addresses in the figure. At time t1, coordinates ((A+A)/2, (A+A)/2) are recorded as the midpoint between coordinates T1 and coordinates T2.

In FIG. 14, in the fields of address: 0 and address: 1, the first letter “0” indicates that a touch at the coordinates is not made, and the first letter “1” indicates that a touch at the coordinates is made.

At time t2, it is assumed that only one point on the touch panel is touched. Here, the coordinates (X1, Y1) at the touch position are recorded in coordinates T1 (address: 0 in the figure). Coordinates T2 (address: 1 in the figure) remain the initial values (A, A). At time t2, coordinates ((X1+A)/2, (Y1+A)/2) are recorded as the midpoint between coordinates T1 and coordinates T2.

At time t2, there is a change in touch/release from the previous time. In step S101 in FIG. 9, therefore, a YES determination is made, and no substantial process in the flowchart in FIG. 9 is performed. Specifically, no process for scroll, drag, pinch, or rotate is performed, and a process for tap not shown in the flowchart is performed. Accordingly, even when the midpoint coordinates are greatly varied due to a change of the initial values (A, A) to the actual touch coordinates (X1, Y1), it is not erroneously determined that the change is caused by a scroll operation or a drag operation.

At time t3, it is assumed that the touched one point is moved. Here, coordinates (X11, Y11) after the movement are recorded in coordinates T1 (address: 0 in the figure). Coordinates T2 (address: 1 in the figure) remain the initial values (A, A). At time t3, coordinates ((X11+A)/2, (Y11+A)/2) are recorded as the midpoint between coordinates T1 and coordinates T2.

At time t3, there is no change in touch/release from the previous time. Therefore, a NO determination is made in step S101 in FIG. 9, and a process of determining the operation (S109 to S113) is performed based on the moving speed of the midpoint between coordinates T1 and coordinates T2. In the determination of the moving speed, for example, it is determined whether coordinates I (midpoint) in FIG. 8 move over a distance greater than the threshold value r from the previous detection timing. If YES, an imaging process in accordance with a scroll operation or a drag operation is performed in step S111 in FIG. 9. If NO, an imaging process is performed in accordance with a pinch operation or a rotate operation in step S113. In FIG. 14, it is assumed that the moving speed of the midpoint is fast (the midpoint is moved), and an imaging process in accordance with a scroll operation is performed.

The threshold value r in FIG. 8 is preferably set to a value greater than the amount of movement of coordinates I that is caused by hand shaking when the user is reducing or increasing the distance between the thumb and the index finger during a pinch operation. Accordingly, even when the midpoint is shaken while the fingers are closed or opened, the shake can be set equal to or smaller than the threshold value. Therefore, even with hand shaking, a pinch operation is not erroneously determined as a scroll operation or a drag operation. The threshold value r is preferably a distance from 5 mm to 20 mm on the touch panel.

At time t4, it is assumed that one point on the touch panel is additionally touched (that is, a state in which, in total, two points are touched). Here, coordinates (X11, Y11) at the touch position are recorded in coordinates T1 (address: 0 in the figure). Coordinates (X2, Y2) at the touch position are recorded in coordinates T2 (address: 1 in the figure). At time t4, coordinates ((X11+X2)/2, (Y11+Y2)/2) are recorded as the midpoint between coordinates T1 and coordinates T2.

At time t4, there is a change in touch/release from the previous time.

Therefore, a YES determination is made in step S101 in FIG. 9, and no substantial process in the flowchart in FIG. 9 is performed. Specifically, no process for scroll, drag, pinch, and rotate is performed, and a process for tap not shown in the flowchart is performed.

At time t5, it is assumed that both of the touched two points are moved. Here, coordinates (X111, Y111) after the movement are recorded in coordinates T1 (address: 0 in the figure). Coordinates (X22, Y22) after the movement are recorded in coordinates T2 (address: 1 in the figure). Coordinates ((X111+X22)/2, (Y111+Y22)/2) are recorded as the midpoint between coordinates T1 and coordinates T2.

At time t5, there is no change in touch/release from the previous time. Therefore, a NO determination is made in step S101 in FIG. 9, and a process of determining the operation (S109 to S113) is performed based on the moving speed of the midpoint between coordinates T1 and coordinates T2. In FIG. 14, it is assumed that the moving speed of the midpoint is slow (or the moving speed is zero), and an imaging process in accordance with pinch-out is performed.

At time t6, it is assumed that the touch at coordinates T1 on the touch panel is released (that is, a state in which, in total, one point is touched). Here, the coordinates (X111, Y111) of the final touch position are held in coordinates T1 (address: 0 in the figure). Coordinates (X22, Y22) at the touch position are recorded in coordinates T2 (address: 1 in the figure). At time t6, coordinates (X111+X22)/2, (Y111+Y22)/2) are recorded as the midpoint between coordinates T1 and coordinates T2.

At t6 in FIG. 14, the touch state at address: 0 is released, and, therefore, the first letter in the field is changed to “0”.

At time t6, there is a change in touch/release from the previous time. Therefore, a YES determination is made in step S101 in FIG. 9, and no substantial process in the flowchart in FIG. 9 is performed. Specifically, no process for scroll, drag, pinch, and rotate is performed, and a process for tap not shown in the flowchart is performed.

At time t7, it is assumed that touch coordinates T2 are moved. Here, coordinates (X111, Y111) of the final touch position are held in coordinates T1 (address: 0 in the figure). Coordinates (X222, Y222) after the movement are recorded in coordinates T2 (address: 1 in the figure). At time t7, coordinates ((X111+X222)/2, (Y111+Y222)/2) are recorded as the midpoint between coordinates T1 and coordinates T2.

At time t7, there is no change in touch/release from the previous time. Therefore, a NO determination is made in step S101 in FIG. 9, and a process of determining the operation (S109 to S113) is performed based on the moving speed of the midpoint between coordinates T1 and coordinates T2. In FIG. 14, it is assumed that the moving speed of the midpoint is fast (the midpoint is moved), and an imaging process in accordance with scroll is performed.

At time t8, it is assumed that a touch at coordinates T1 on the touch panel is made again (that is, a state in which, in total, two points are touched). Here, coordinates (X3, Y3) of the touch position are held in coordinates T1 (address: 0 in the figure). Coordinates (X222, Y222) at the touch position are recorded in coordinates T2 (address: 1 in the figure). At time t8, coordinates ((X3+X222)/2, (Y3+Y222)/2) are recorded as the midpoint between coordinates T1 and coordinates T2.

At t8 in FIG. 14, a touch at address: 0 is made, and, therefore, the first letter in the field is changed to “1”.

At time t8, there is a change in touch/release from the previous time. Therefore, a YES determination is made in step S101 in FIG. 9, and no substantial process in the flowchart in FIG. 9 is performed. Specifically, no process for scroll, drag, pinch, or rotate is performed, and a process for tap not shown in the flowchart is performed.

At time t9, it is assumed that both of the touched two points are moved. Here, coordinates (X33, Y33) after the movement are recorded in coordinates T1 (address: 0 in the figure). Coordinates (X2222, Y2222) after the movement are recorded in coordinates T2 (address: 1 in the figure). At time t9, coordinates ((X33+X2222)/2, (Y33+Y2222)/2) are recorded as the midpoint between coordinates T1 and coordinates T2.

At time t9, there is no change in touch/release from the previous time. Therefore, a NO determination is made in step S101 in FIG. 9, and a process of determining the operation (S109 to S113) is performed based on the moving speed of the midpoint between coordinates T1 and coordinates T2. In FIG. 14, it is assumed that the moving speed of the midpoint is slow (or the moving speed is zero), and an imaging process in accordance with pinch-out is performed.

At time t10, it is assumed that touch coordinates T2 are moved. Here, coordinates (X33, Y33) of the touch position are held in coordinates T1 (address: 0 in the figure). Coordinates (X22222, Y22222) after the movement are recorded in coordinates T2 (address: 1 in the figure). At time t10, coordinates ((X33+X22222)/2, (Y33+Y22222)/2) are recorded as the midpoint between coordinates T1 and coordinates T2.

At time t10, there is no change in touch/release from the previous time. Therefore, a NO determination is made in step S101 in FIG. 9, and a process of determining the operation (S109 to S113) is performed based on the moving speed of the midpoint between coordinates T1 and coordinates T2. In FIG. 14, it is assumed that the moving speed of the midpoint is fast (the midpoint is moved), and an imaging process in accordance with scroll is performed.

As described above, in the first embodiment, a midpoint is obtained from the touch positions, and the operation by the user is determined based on a state of movement. An imaging process is performed based on the determination result.

### Second Embodiment

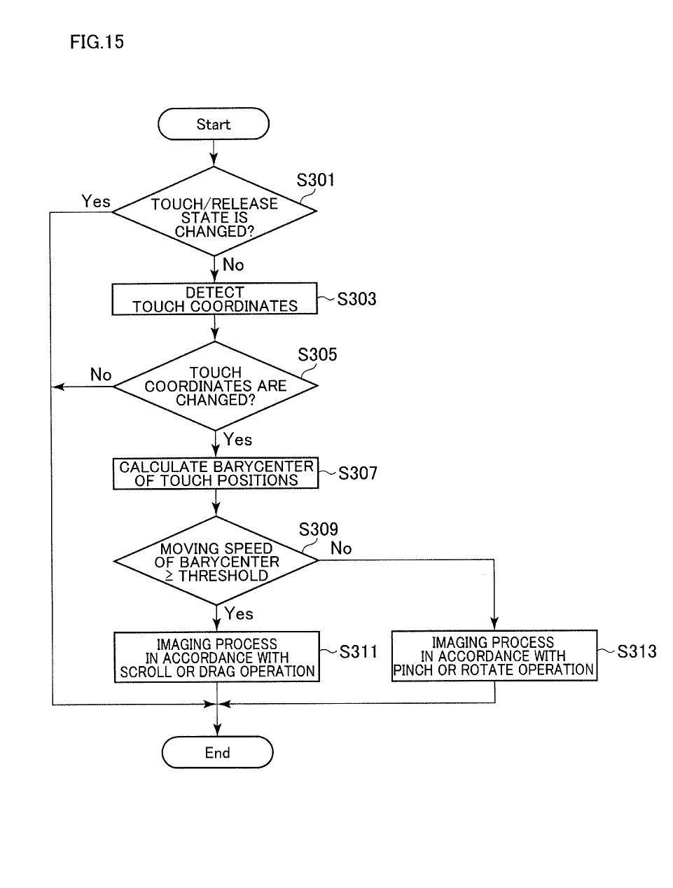

FIG. 15 is a flowchart showing a process executed by CPU 11 of the information processing apparatus in a second embodiment.

The information processing apparatus in the second embodiment executes a process illustrated in the flowchart in FIG. 15 in place of the process in the flowchart in FIG. 9. The information processing apparatus in the second embodiment records the touch positions at the third and subsequent points in the field of “address 2” and the subsequent fields in FIG. 14, and calculates the barycenter position of a plurality of touch positions in place of the midpoint. The user's operation is determined based on a movement of the barycenter position.

The process in the flowchart in FIG. 15 is repeatedly performed at predetermined time intervals (for example, every 20 milliseconds).

The process in steps S301 to S305 in FIG. 15 is the same as the process in steps S101 to S105 in FIG. 9, and a description thereof is not repeated here.

If YES in step S305, in step S307, the barycenter position of a plurality of touch positions is calculated as coordinates I.

In step S309, it is determined whether the moving speed of coordinates I is equal to or greater than a threshold value. In step S309, it may be determined whether coordinates I are moved, or whether the amount of the movement within a predetermined time is equal to or greater than a threshold value.

If YES in step S309, in step S311, it is determined that the operation by the user is a scroll operation or a drag operation, and a screen imaging process in accordance with a scroll operation or a drag operation is performed. The determination as to whether the operation is a scroll operation or a drag operation is made, for example, based on the display content of the screen, the display content at the touch position, and the time interval from when a touch is made to when the touch position is moved.

If NO in step S309, in step S313, it is determined that the operation by the user is a pinch-in operation, a pinch-out operation, or a rotate operation, and a screen imaging process in accordance with a pinch-in operation, a pinch-out operation, or a rotate operation is performed. Whether the operation is a pinch-in operation, a pinch-out operation, or a rotate operation is determined based on the direction in which the touch position is moved. Specifically, when the touch positions at two or more points are rotated in a predetermined direction about the midpoint, it is determined that the operation is a rotate operation. If the touch positions at two or more points are moved in a direction toward the midpoint, it is determined that the operation is a pinch-in operation. If the touch positions at two or more points are moved in a direction away from the midpoint, it is determined that the operation is a pinch-out operation.

The second embodiment has the effect of significantly reducing the processing irrespective of whether the touch/release state is changed or not, in the same manner as in the first embodiment.

### Third Embodiment

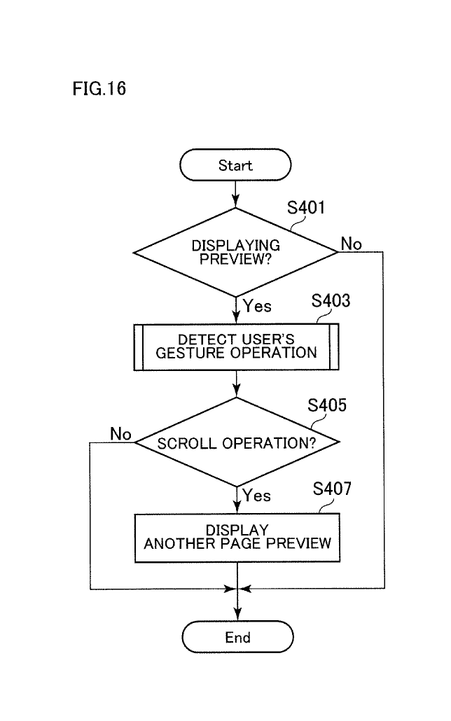

FIG. 16 is a flowchart showing a process executed by CPU 11 of the information processing apparatus in a third embodiment.

Referring to FIG. 16, in step S401, it is determined whether a preview is being displayed on the touch panel. A preview is a reduced image of at least one page from among images (scanned images, externally received images) of a plurality of pages stored in storage device 23.

If NO in step S401, the process here ends. If YES, the process from step S403 is executed. In step S403, a subroutine of detecting a user's gesture operation is executed. The process in this subroutine is the same as the process in steps S101 to S107 in FIG. 9 or in steps S301 to S307 in FIG. 15.

In step S405, it is determined whether the operation made by the user is a scroll operation by determining whether the moving speed of the midpoint or barycenter is equal to or greater than a threshold value. If YES, in step S407, an image of another page (a previous page or a next image in accordance with the direction of the scroll operation) is displayed on the touch panel.

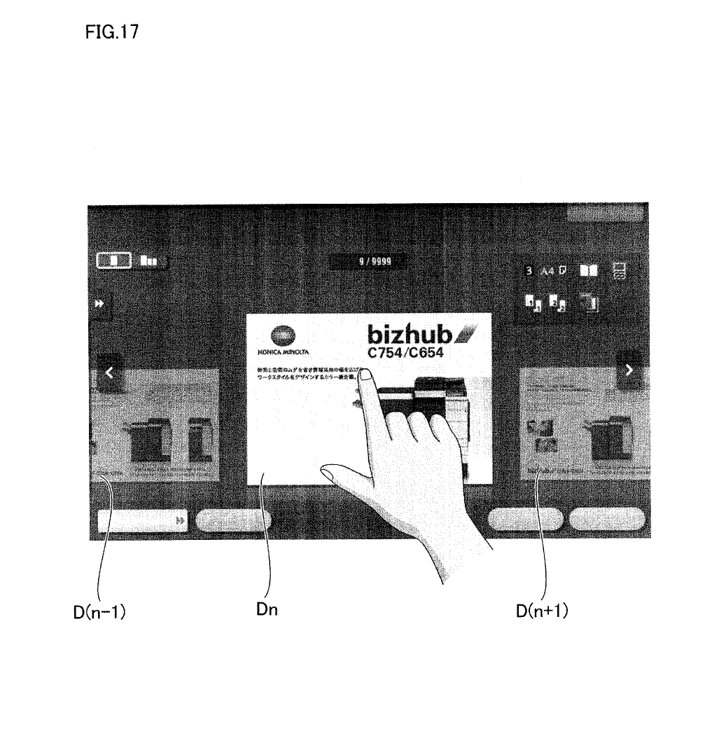

FIG. 17 is a diagram showing a specific example of a display content on the touch panel of the information processing apparatus in the third embodiment.

in a case where an image of the Dn-th page is previewed at the center of the screen, when the user touches the screen to move the touch position to the left, an image of the next page (D(n+1)th page) that has been grayed out is moved to the center of the screen, and the image of the D(n+1)th page is to be previewed. In a case where an image of the Dn-th page is previewed at the center of the screen, when the user touches the screen to move the touch position to the right, an image of the previous page (D(n−1)th page) that has been grayed out is moved to the center of the screen, and the image of the D(n−1)th page is to be previewed.

### Fourth Embodiment

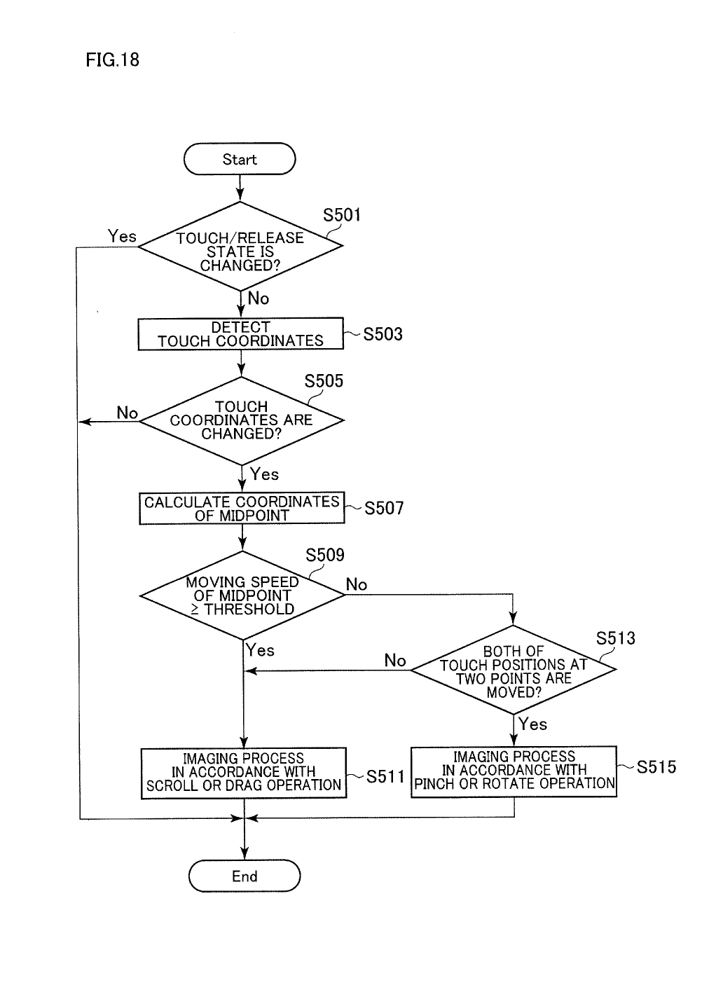

FIG. 18 is a flowchart showing a process executed by CPU 11 of the information processing apparatus in a fourth embodiment.

The information processing apparatus in the fourth embodiment executes a process illustrated in the flowchart in FIG. 18 in place of the process in the flowchart in FIG. 9.

The process in the flowchart in FIG. 18 is repeatedly executed at predetermined time intervals (for example, every 20 milliseconds).

The process in steps S501 to S511 and S515 in FIG. 18 is the same as the process in steps S101 to S111 and S113 in FIG. 9, and a description thereof is not repeated here.

In FIG. 18, if NO in step S509, in step S513, it is determined whether both of the touch positions at two points are moved. If YES in step S513, the process proceeds to step S515. If NO, the process proceeds to step S511.

In the fourth embodiment, the process for a pinch-in operation, a pinch-out operation, or a rotate operation is performed only when both of touch positions at two points are moved. This has the effect of preventing an erroneous process against the user's intention.

### Fifth Embodiment

In the forgoing first to fourth embodiments, a fixed threshold value is used to determine the user's operation based on a movement of the center (or barycenter). In a fifth embodiment, however, the threshold value is varied according to situations.

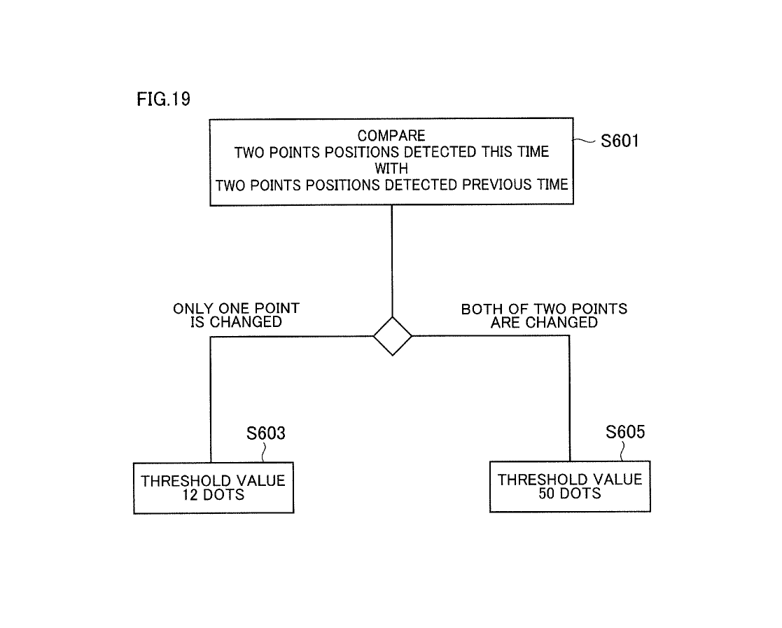

FIG. 19 is a flowchart showing a process executed by CPU 11 of the information processing apparatus in the fifth embodiment.

The flowchart in FIG. 19 illustrates a process of changing the threshold value. The process shown in FIG. 19 can be executed concurrently with the process in the flowchart illustrated in the first to fourth embodiments.

In step S601, when there is a change in touch position, it is determined whether only a touch position at one point is changed or both of touch positions at two points are changed. If only a touch position at one point is changed, in step S603, the threshold value is reduced, for example, to 12 dots. If both of touch positions at two points are changed, in step S605, the threshold value is increased, for example, to 50 dots.

When only a touch position at one point is changed, there is a high possibility that the user's operation is a scroll operation or a drag operation. In step S603, therefore, the threshold value is reduced to facilitate a determination that the operation is a scroll operation or a drag operation. On the other hand, when both of touch positions at two points are changed, there is a high possibility that the user's operation is a pinch-in operation, a pinch-out operation, or a rotate operation. In step S605, therefore, the threshold value is increased to facilitate a determination that the operation is a pinch-in operation, a pinch-out operation, or a rotate operation.

### Sixth Embodiment

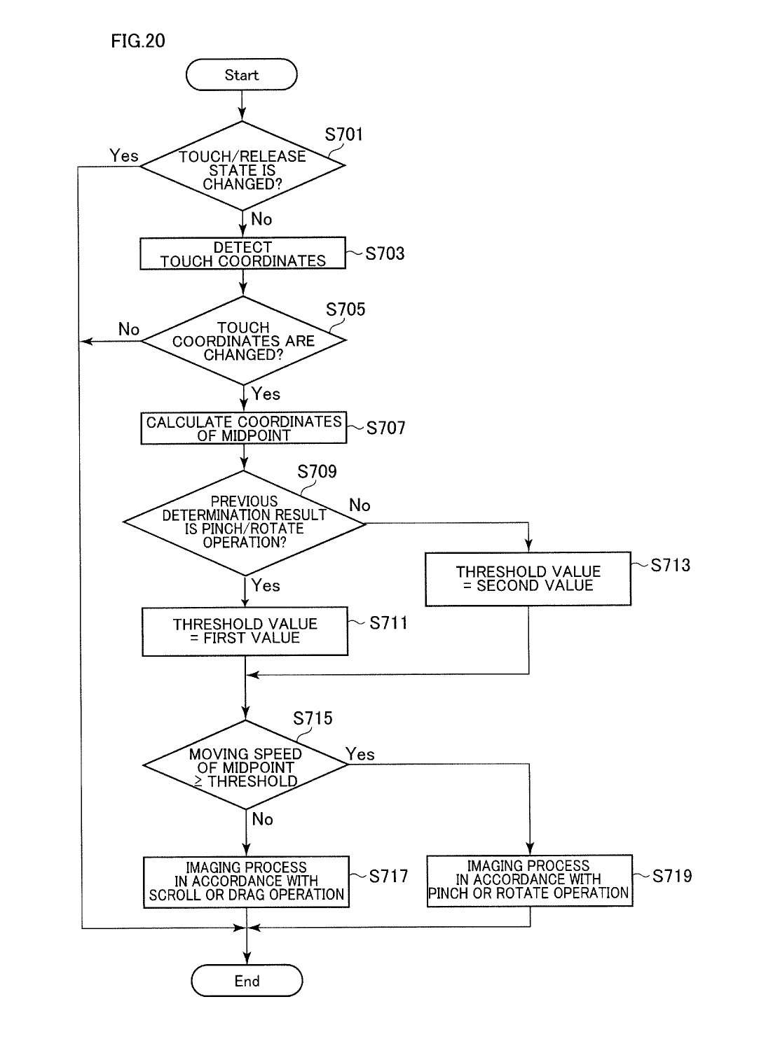

FIG. 20 is a flowchart showing a process executed by CPU 11 of the information processing apparatus in a sixth embodiment.

The information processing apparatus in the sixth embodiment executes a process illustrated in the flowchart in FIG. 20 in place of the process in the flowchart in FIG. 9.

The process in the flowchart in FIG. 20 is repeatedly executed at predetermined time intervals (for example, every 20 milliseconds).

The process in steps S701 to S707 in FIG. 20 is the same as the process in steps S101 to S107 in FIG. 9, and a description thereof is not repeated here.

After the process in step S707, in step S709, it is determined whether the previous determination result of the user's operation is a pinch operation or a rotate operation. If YES, in step S711, a first value is set for the threshold value. If NO, in step S713, a second value is set for the threshold value. Here, the relationship of the first value>the second value holds. The process from step S715 is thereafter performed. The process in steps S715 to S719 in FIG. 20 is the same as the process in steps S109 to S113 in FIG. 9, and a description thereof is not repeated here.

When the previous determination result of the user's operation is a pinch operation or a rotate operation, there is a high possibility that the user's operation at the next detection timing is also a pinch operation or a rotate operation. In step S711, therefore, the threshold value is increased to facilitate a determination that the operation is a pinch operation or a rotate operation. On the other hand, if the previous determination result of the user's operation is a scroll operation or a drag operation, there is a high possibility that the user's operation at the next detection timing is also a scroll operation or a drag operation. In step S713, therefore, the threshold value is reduced to facilitate a determination that the operation is a scroll operation or a drag operation.

### Seventh Embodiment

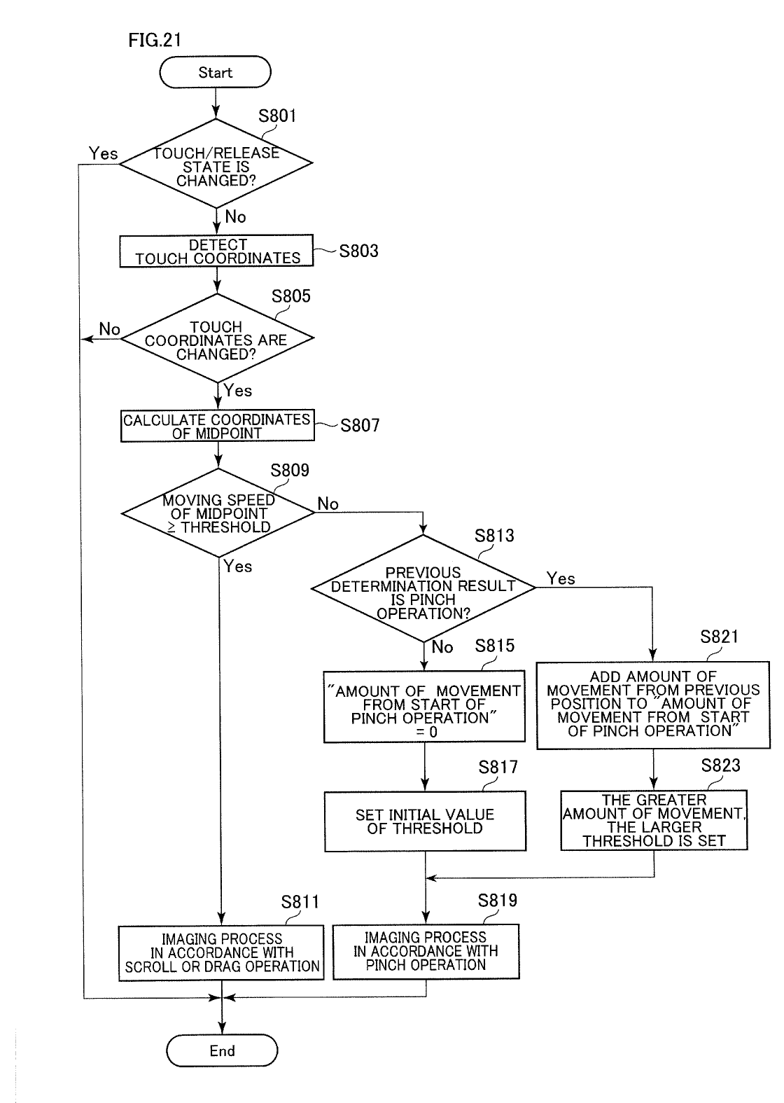

FIG. 21 is a flowchart showing a process executed by CPU 11 of the information processing apparatus in a seventh embodiment.

The information processing apparatus in the seventh embodiment executes a process illustrated in the flowchart in FIG. 21 in place of the process in the flowchart in FIG. 9.

The process in the flowchart in FIG. 21 is repeatedly executed at predetermined time intervals (for example, every 20 milliseconds).

The process in steps S801 to S811 in FIG. 21 is the same as the process in steps S101 to S111 in FIG. 9, and a description thereof is not repeated here.

If NO in step S809, in step S813, it is determined whether the previous determination result of the user's operation is a pinch operation. If NO, assuming that a pinch operation is started, and, in step S815, “0” is recorded as “the amount of movement of the touch position from the start of pinch operation”. In step S817, then, an initial value of the threshold value is set. The threshold value set here may be the same as the threshold value previously used in step S809 or may be greater. If a greater threshold value is set, a NO determination is facilitated in the determination in step S809 in the next period. Specifically, if a NO determination is once made in step S809 (if it is determined that the operation is pinch), a determination that the operation is a pinch operation is facilitated in the determination in the next period.

In step S819, an imaging process in accordance with a pinch operation is performed. Here, the determination of a rotate process is omitted.

If a YES determination is made in step S813, in step S821, the amount of movement from the previous touch position is added to the “amount of movement of the touch position from the start of pinch operation”. In step S823, a threshold value is set based on the value of the “amount of movement of the touch position from the start of pinch operation”. Here, the greater is the “amount of movement of the touch position from the start of pinch operation”, the larger threshold value is set.

When the previous determination result of the user's operation is a pinch operation, there is a high possibility that the user's operation at the next detection timing is also a pinch operation. In step S823, therefore, the threshold value is increased to facilitate a determination that the operation is a pinch operation, also in the next determination. Here, as the pinch operation continues, the threshold value is increased.

### Eighth Embodiment

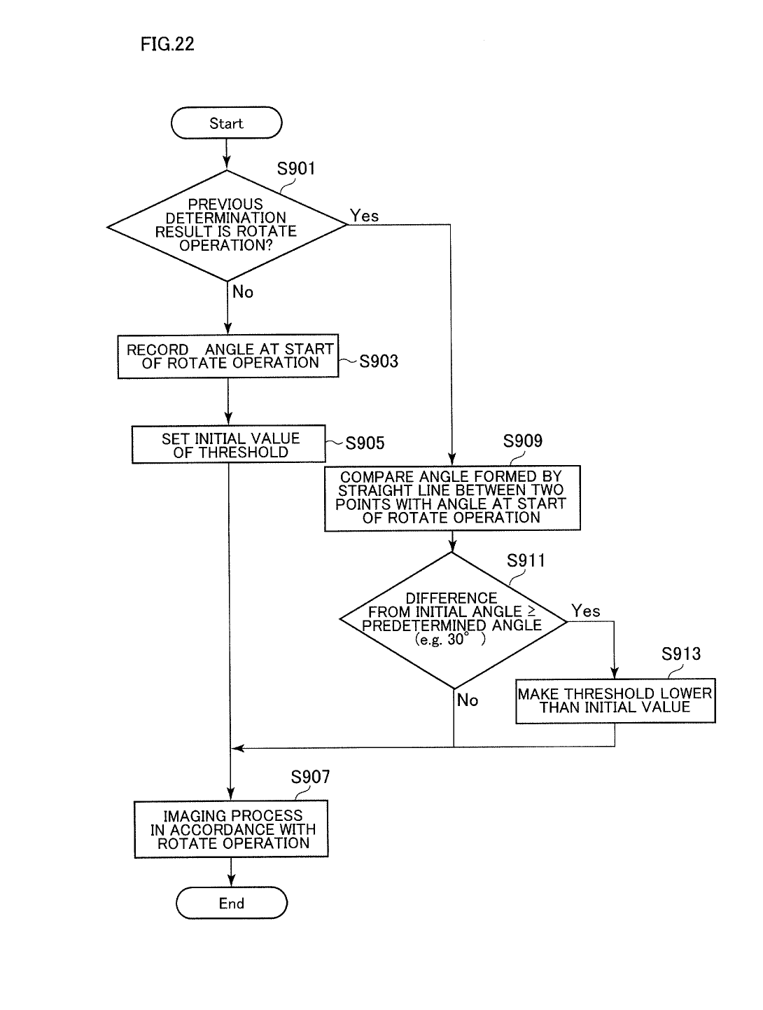

FIG. 22 is a flowchart showing a process executed by CPU 11 of the information processing apparatus in an eighth embodiment.

The information processing apparatus in the eighth embodiment executes a process illustrated in the flowchart in FIG. 22 in place of the process in steps S813 to S823 in the flowchart in FIG. 21.

Specifically, if NO in step S809 (FIG. 21), in step S901 (FIG. 22), it is determined whether the previous determination result of the user's operation is a rotate operation. If NO, assuming that a rotate operation is started, in step S903, the angle at the start of rotation operation (the angle formed by a straight line between touch positions at two points at the start of rotate operation) is recorded. In step S905, then, an initial value of the threshold value is set. The threshold value set here may be the same as the threshold value previously used in step S809 or may be greater. If a greater threshold value is set, a NO determination is facilitated in the determination in step S809 in the next period. That is, if a NO determination is once made in step S809 (if it is determined that the operation is rotate), a determination that the operation is a rotate operation is facilitated also in the determination in the next period.

In step S907, an imaging process in accordance with a rotate operation is performed. Here, the determination of a pinch process is omitted.

If a YES determination is made in step S901, in step S909, the angle formed by a straight line between the touch positions at two points at present is compared with the angle at the start of rotate operation that is recorded in step S903. In step S911, it is determined whether the result of comparison is equal to or greater than a predetermined angle (for example, 30°). If YES, in step S913, the threshold value is set to a value smaller than the initial value, and the process proceeds to step S907. If NO, the process proceeds to step S907.

There is a high possibility that a rotate operation ends approximately at 30°. Therefore, if the rotation from the initial angle is 30° or greater in step S911, in step S913, the threshold value is reduced. This facilitates a determination that the operation is a scroll operation or a drag operation, in the next determination.

### Ninth Embodiment

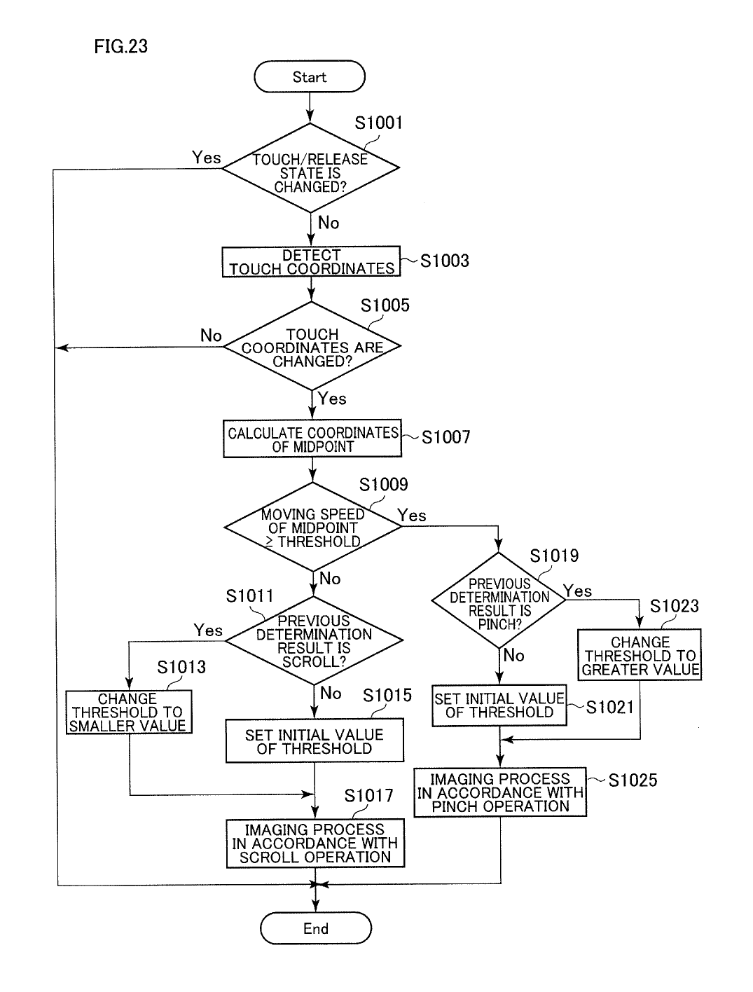

FIG. 23 is a flowchart showing a process executed by CPU 11 of the information processing apparatus in a ninth embodiment.

The information processing apparatus in the ninth embodiment executes a process illustrated in the flowchart in FIG. 23 in place of the process in the flowchart in FIG. 9.

The process in the flowchart in FIG. 23 is repeatedly executed at predetermined time intervals (for example, every 20 milliseconds).

The process in steps S1001 to S1009 in FIG. 23 is the same as the process in steps S101 to S109 in FIG. 9, and a description thereof is not repeated here.

If YES in step S1009, in step S1011, it is determined whether the previous determination result of the user's operation is a scroll operation. If NO, assuming that a scroll operation is started, in step S1015, an initial value is set as a threshold value. The threshold value set here may be the same as the threshold value previously used in step S1009 or may be smaller. If a smaller threshold value is set, a YES determination is facilitated in the determination in step S1009 in the next period. That is, if a YES determination is once made in step S1009 (if it is determined that the operation is a scroll operation), a determination that the operation is a scroll operation is facilitated also in the determination in the next period.

If YES in step S1011, in step S1013, the threshold value is changed to a smaller value. If a smaller threshold value is set, a YES determination is facilitated in the determination in step S1009 in the next period. In step S1017, an imaging process in accordance with a scroll operation is performed. Here, the determination of a drag process is omitted.

If NO in step S1009, in step S1019, it is determined whether the previous determination result of the user's operation is a pinch operation. If NO, assuming that a pinch operation is started, in step S1021, an initial value is set as a threshold value. Here, the threshold value set here may be the same as the threshold value previously used in step S1009 or may be greater. If a greater threshold value is set, a NO determination is facilitated in the determination in step S1009 in the next period. That is, if a NO determination is once made in step S1009 (if it is determined that the operation is a pinch operation), a determination that the operation is a pinch operation is facilitated also in the determination in the next period.

If YES in step S1019, in step S1023, the threshold value is changed to a greater value. If a greater threshold value is set, a NO determination is facilitated in the determination in step S1009 in the next period. In step S1025, an imaging process in accordance with a pinch operation is performed. Here, the determination of a rotate process is omitted.

### Effect of Embodiments

According to the embodiments above, in the information processing apparatus installed with a touch panel capable of detecting two or more points, the coordinates of two or more points are always detected irrespective of a touch state or a release state. The coordinates include actual values (the actual touch position at present) and stored values (the final touch position). Based on these coordinates of two or more points, a position (for example, midpoint) obtained by a predetermined rule is calculated. The user's operation is determined based on a variation in the obtained position.

The process in the present embodiment only requires processing in a CPU, for example, shift processing. For example, the midpoint of coordinates that requires less processing time is always detected, so that the user's operation can be determined from the detected midpoint using the characteristic that the midpoint greatly varies during scroll (flick) and the midpoint is hardly moved during pinch. That is, the process of determining a gesture operation can be implemented with a simple process.

According to the foregoing embodiments, even when two or more points on the touch panel are touched, when the touch position is moved quickly and the coordinates of the midpoint (or barycenter) are thereby moved quickly, the process in accordance with a scroll operation or a drag operation is performed. This has the effect of good operability for users.

### OTHERS

In the forgoing embodiments, an information processing apparatus installed in an image forming apparatus (or image processing apparatus) has been described by way of example. The present invention, however, is applicable to an information processing apparatus installed as a user interface in smart phones, tablet terminals, PCs (Personal Computers), home appliances, office appliances, and controllers.

The image forming apparatus may be any of a monochrome/color copier, a printer, a facsimile machine, or an MFP (Multi-Functional Peripheral). The image forming apparatus may be the one that forms an image by an electrophotographic technique or the one that forms an image by an ink-jet technique.

The process in the forgoing embodiments may be performed either by software or by a hardware circuit.

A program for executing the process in the foregoing embodiments may be provided. A recording medium, such as a CD-ROM, a flexible-disk, a hard disk, a ROM, a RAM, or a memory card, encoded with the program may be provided to users. The program may be downloaded to the apparatus through a communication circuit such as the Internet. The process described in written form in the flowchart is executed by a CPU in accordance with the program.

The embodiments above provide an information processing apparatus that can make processing easy, a method of controlling the information processing apparatus, and a control program for the information processing apparatus. An information processing apparatus with good operability for users is also provided.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An information processing apparatus comprising:
a detection unit capable of detecting a first touch position and a second touch position on a touch panel that are touched by a first object and a second object, respectively;
a storage unit that stores the first touch position and the second touch position that are detected by the detection unit, the storage unit holding a final touch position by the first object as the first touch position after a touch by the first object is released, and holding a final touch position by the second object as the second touch position after a touch by the second object is released;
a calculation unit that calculates a position obtained by a predetermined rule from the first touch position and the second touch position that are stored by the storage unit; and
a determination unit that determines whether an operation performed on the touch panel is an operation of moving a display content displayed on the touch panel, or an operation of rotating or changing a size of a display content displayed on the touch panel, based on whether the position calculated by the calculation unit is moved, a speed of movement, or an amount of movement.

2. The information processing apparatus according to claim 1, wherein
the position calculated by the calculation unit is a position that is moved when the operation of moving a display content displayed on the touch panel is performed, and
when the operation of moving a display content displayed on the touch panel is performed, the position calculated by the calculation unit is moved more than when an operation of rotating or changing a size of a display content displayed on the touch panel is performed.

3. The information processing apparatus according to claim 1, wherein the calculation unit calculates a midpoint between the first touch position and the second touch position.

4. The information processing apparatus according to claim 1, wherein
the detection unit is capable of detecting a third touch position on the touch panel that is touched by a third object,
the storage unit stores the third touch position detected by the detection unit, and holds a final touch position by the third object as the third touch position after a touch by the third object is released, and
the calculation unit calculates a barycenter of the first touch position, the second touch position, and the third touch position, from the first touch position, the second touch position, and the third touch position.

5. The information processing apparatus according to claim 1, wherein when the position calculated by the calculation unit is not moved, when a speed of movement is smaller than a threshold value, or when an amount of movement is smaller than a threshold value, the determination unit determines that the operation performed on the touch panel is the operation of rotating or changing a size of a display content displayed on the touch panel.

6. The information processing apparatus according to claim 1, wherein when the position calculated by the calculation unit is moved, when a speed of movement is equal to or greater than a threshold value, or when an amount of movement is equal to or greater than a threshold value, the determination unit determines that the operation performed on the touch panel is the operation of moving a display content displayed on the touch panel.

7. The information processing apparatus according to claim 1, wherein when the position calculated by the calculation unit is not moved, when a speed of movement is smaller than a threshold value, or when an amount of movement is smaller than a threshold value, and when the first touch position and the second touch position are moved, the determination unit determines that the operation performed on the touch panel is the operation of rotating or changing a size of a display content displayed on the touch panel.

8. The information processing apparatus according to claim 5, wherein a value of the threshold value is changed between when both of the first touch position and the second touch position are moved and when one of the first touch position and the second touch position is moved.

9. The information processing apparatus according to claim 8, wherein when both of the first position and the second position are moved, a value of the threshold value is set greater than when one of the first touch position and the second touch position is moved.

10. The information processing apparatus according to claim 5, wherein the threshold value is changed based on a result of previous determination by the determination unit.

11. The information processing apparatus according to claim 5, wherein when a result of previous determination by the determination unit is the operation of rotating or changing a size of a display content, the threshold value is increased based on amounts of movement of the first touch position and the second touch position from the start of the operation.

12. The information processing apparatus according to claim 5, wherein when a result of previous determination by the determination unit is the operation of rotating a display content, the threshold value is increased from the start of the operation until rotation at a predetermined angle is made.

13. The information processing apparatus according to claim 5, wherein
when a result of previous determination by the determination unit is the operation of rotating or changing a size of a display content, the threshold value is increased, and
when a result of previous determination by the determination unit is the operation of moving a display content, the threshold value is reduced.

14. The information processing apparatus according to claim 1, wherein the calculation unit calculates the first touch position and the second touch position by a same weight.

15. The information processing apparatus according to claim 1, wherein
the calculation unit performs a calculation periodically, and
the determination unit determines whether the position calculated by the calculation unit is moved, a speed of movement, or an amount of movement, using a result calculated by the calculation in the past and a result newly calculated.

16. The information processing apparatus according to claim 1, wherein
the storage unit stores an initial value as the first touch position and the second touch position before a touch is made, and
when the initial value is changed to an actual touch position by making a touch, the determination unit does not determine that the operation performed on the touch panel is the operation of moving a display content displayed on the touch panel.

17. The information processing apparatus according to claim 1, further comprising a display unit that displays at least an image of one page of images of a plurality of pages,
wherein when the determination unit determines that the operation performed on the touch panel is the operation of moving a display content displayed on the touch panel, an image displayed on the display unit is changed to an image of a next or previous page.

18. The information processing apparatus according to claim 1, wherein
the operation of moving a display content displayed on the touch panel is a scroll operation or a drag operation, and
the operation of changing a size of a display content displayed on the touch panel is a pinch-in operation or a pinch-out operation.

19. A method of controlling an information processing apparatus including a detection unit capable of detecting a first touch position and a second touch position on a touch panel that are touched by a first object and a second object, respectively, comprising:
storing the first touch position and the second touch position that are detected by the detection unit, wherein a final touch position by the first object is held as the first touch position after a touch by the first object is released, and a final touch position by the second object is held as the second touch position after a touch by the second object is released;
calculating a position obtained by a predetermined rule from the stored first touch position and second touch position; and
determining whether an operation performed on the touch panel is an operation of moving a display content displayed on the touch panel, or an operation of rotating or changing a size of a display content displayed on the touch panel, based on whether the calculated position is moved, a speed of movement, or an amount of movement.

20. A non-transitory computer-readable recording medium for controlling an information processing apparatus, the computer-readable recording medium having a program causing a computer to execute processing,
the information processing apparatus including a detection unit capable of detecting a first touch position and a second touch position on a touch panel that are touched by a first object and a second object, respectively,
the program causing a computer to execute processing comprising:
storing the first touch position and the second touch position that are detected by the detection unit, wherein a final touch position by the first object is held as the first touch position after a touch by the first object is released, and a final touch position by the second object is held as the second touch position after a touch by the second object is released;
calculating a position obtained by a predetermined rule from the stored first touch position and second touch position; and
determining whether an operation performed on the touch panel is an operation of moving a display content displayed on the touch panel, or an operation of rotating or changing a size of a display content displayed on the touch panel, based on whether the calculated position is moved, a speed of movement, or an amount of movement.
